(19) United States
(12) Patent Application Publication
(10) Pub. No.: US 2020/0270435 A1
(43) Pub. Date: Aug. 27, 2020

(54) METHOD FOR MAKING HETEROPHASIC POLYMER COMPOSITIONS

(71) Applicant: Milliken & Company, Spartanburg, SC (US)

(72) Inventors: Francisco Alvarez, Mars, PA (US); Keith A. Keller, Spartanburg, SC (US); Clifford S. Bynum, Inman, SC (US); Scott R. Trenor, Greenville, SC (US); Jason D. Sprinkle, Woodruff, SC (US)

(21) Appl. No.: 16/797,504

(22) Filed: Feb. 21, 2020

Related U.S. Application Data
(60) Provisional application No. 62/811,245, filed on Feb. 27, 2019.

(51) Int. Cl. C08L 23/12; C08L 23/08; C08L 23/06; C08L 23/14

(52) U.S. Cl. CPC C08L 23/12; C08L 23/0815; C08K 5/521; C08L 23/142; C08L 23/06

(57) ABSTRACT

A heterophasic polymer composition comprises a propylene polymer phase, an ethylene polymer phase, a compatibilizing agent comprising a fulvene moiety, and a nucleating agent. A method for modifying a heterophasic polymer composition comprises the steps of providing a compatibilizing agent, providing a nucleating agent, providing a heterophasic polymer composition comprising a propylene polymer phase and an ethylene polymer phase, mixing the compatibilizing agent, the nucleating agent, and the heterophasic polymer composition, and generating free radicals in the propylene phase and the ethylene phase. At least a portion of the compatibilizing agent then reacts with free radicals in both the propylene polymer phase and the ethylene polymer phase to form a bond with a propylene polymer in the propylene polymer phase and a bond with an ethylene polymer in the ethylene polymer phase.

### CROSS-REFERENCE TO RELATED PATENT APPLICATIONS

This application claims, pursuant to 35 U.S.C. § 119(e), priority to and the benefit of the filing date of U.S. Patent Application No. 62/811,245, which was filed on Feb. 27, 2019, the contents of which are hereby incorporated by reference.

### TECHNICAL FIELD OF THE INVENTION

The present invention is directed to heterophasic polyolefin compositions having increased melt flow rates, as well as high impact strength, and methods for making such compositions. Of particular interest are modified polypropylene impact copolymers.

### BACKGROUND

The melt flow rate (MFR) of a polymer resin is a function of its molecular weight. In general, increasing the melt flow rate allows the resin to be processed at lower temperatures and to fill complex part geometries. Various prior art methods of increasing the melt flow rate involve melt-blending the resin in an extruder with a compound capable of generating free radicals, such as a peroxide. When this is done, the weight average molecular weight of the polymer is reduced and the MFR is increased. Increasing the melt flow rate by decreasing the molecular weight of the polyolefin polymer, however, has been found in many cases to have a detrimental effect on the strength of the modified polymer. For example, decreasing the molecular weight of the polymer can significantly lower the impact resistance of the polymer. And this lowered impact resistance can make the polymer unsuitable for use in certain applications or end uses. Accordingly, when extant technologies are utilized, one must strike a compromise between increasing the melt flow rate and undesirably decreasing the impact resistance of the polymer. This compromise often means that the melt flow rate is not increased to the desired level, which requires higher processing temperatures and/or results in lower throughputs.

A need therefore remains for additives and processes that can produce polymer compositions having an increased high melt flow while preserving, or even improving, the impact resistance of the polymer.

### BRIEF SUMMARY OF THE INVENTION

In a first embodiment, the invention provides a heterophasic polymer composition comprising:

(a) a propylene polymer phase comprising propylene polymers selected from the group consisting of polypropylene homopolymers and copolymers of propylene and up to 50 wt. % of one or more comonomers selected from the group consisting of ethylene and C₄-C₁₀ α-olefin monomers;

(b) an ethylene polymer phase comprising ethylene polymers selected from the group consisting of ethylene homopolymers and copolymers of ethylene and one or more C₃-C₁₀ α-olefin monomers;

(c) a compatibilizing agent comprising a fulvene moiety; and

(d) a nucleating agent.

In a second embodiment, the invention provides a method for modifying a heterophasic polymer composition, the method comprising the steps of:

(a) providing a compatibilizing agent, the compatibilizing agent comprising a fulvene moiety;

(b) providing a nucleating agent;

(c) providing a heterophasic polymer composition, the heterophasic polymer composition comprising a propylene polymer phase and an ethylene polymer phase;

(d) mixing the compatibilizing agent, the nucleating agent, and the heterophasic polymer composition; and

(e) generating free radicals in the propylene polymer phase and the ethylene polymer phase, whereby at least a portion of the compatibilizing agent reacts with free radicals in both the propylene polymer phase and the ethylene polymer phase to form a bond with a propylene polymer in the propylene polymer phase and a bond with an ethylene polymer in the ethylene polymer phase.

### DETAILED DESCRIPTION

The following definitions are provided to define several of the terms used throughout this application.

As used herein, the term “hydrocarbyl groups” refers to univalent functional groups derived from hydrocarbons by removal of a hydrogen atom from a carbon atom of the hydrocarbon.

As used herein, the term “substituted hydrocarbyl groups” refers to univalent functional groups derived from substituted hydrocarbons by removal of a hydrogen atom from a carbon atom of the substituted hydrocarbon. In this definition, the term “substituted hydrocarbon” refers to compounds derived from acyclic, monocyclic, and polycyclic, unbranched and branched hydrocarbons in which (1) one or more of the hydrogen atoms of the hydrocarbon is replaced with a non-hydrogen atom (e.g., a halogen atom) or a non-hydrocarbyl functional group (e.g., a hydroxy group or heteroaryl group) and/or (2) the carbon-carbon chain of the hydrocarbon is interrupted by an oxygen atom (e.g., as in an ether), a nitrogen atom (e.g., as in an amine), or a sulfur atom (e.g., as in a sulfide).

As used herein, the term “substituted alkyl groups” refers to univalent functional groups derived from substituted alkanes by removal of a hydrogen atom from a carbon atom of the alkane. In this definition, the term “substituted alkanes” refers to compounds derived from acyclic unbranched and branched hydrocarbons in which (1) one or more of the hydrogen atoms of the hydrocarbon is replaced with a non-hydrogen atom (e.g., a halogen atom) or a non-alkyl functional group (e.g., a hydroxy group, aryl group, or heteroaryl group) and/or (2) the carbon-carbon chain of the hydrocarbon is interrupted by an oxygen atom (as in an ether), a nitrogen atom (as in an amine), or a sulfur atom (as in a sulfide).

As used herein, the term “substituted cycloalkyl groups” refers to univalent functional groups derived from substituted cycloalkanes by removal of a hydrogen atom from a carbon atom of the cycloalkane. In this definition, the term “substituted cycloalkanes” refers to compounds derived from saturated monocyclic and polycyclic hydrocarbons (with or without side chains) in which (1) one or more of the hydrogen atoms of the hydrocarbon is replaced with a non-hydrogen atom (e.g., a halogen atom) or a non-alkyl functional group (e.g., a hydroxy group, aryl group, or heteroaryl group) and/or (2) the carbon-carbon chain of the hydrocarbon is interrupted by an oxygen atom, a nitrogen atom, or a sulfur atom.

As used herein, the term “alkenyl groups” refers to univalent functional groups derived from acyclic, unbranched and branched olefins (i.e., hydrocarbons having one or more carbon-carbon double bonds) by removal of a hydrogen atom from a carbon atom of the olefin.

As used herein, the term “substituted alkenyl groups” refers to univalent functional groups derived from acyclic, substituted olefins by removal of a hydrogen atom from a carbon atom of the olefin. In this definition, the term “substituted olefins” refers to compounds derived from acyclic, unbranched and branched hydrocarbons having one or more carbon-carbon double bonds in which (1) one or more of the hydrogen atoms of the hydrocarbon is replaced with a non-hydrogen atom (e.g., a halogen atom) or a non-alkyl functional group (e.g., hydroxy group, aryl group, heteroaryl group) and/or (2) the carbon-carbon chain of the hydrocarbon is interrupted by an oxygen atom (as in an ether) or a sulfur atom (as in a sulfide).

As used herein, the term “substituted cycloalkenyl groups” refers to univalent functional groups derived from substituted cycloalkenes by removal of a hydrogen atom from a carbon atom of the cycloalkene. In this definition, the term “substituted cycloalkenes” refers to compounds derived from monocyclic and polycyclic olefins (i.e., hydrocarbons having one or more carbon-carbon double bonds) in which one or more of the hydrogen atoms of the olefin is replaced with a non-hydrogen atom (e.g., a halogen atom) or a non-alkyl functional group (e.g., a hydroxy group, aryl group, or heteroaryl group).

As used herein, the term “substituted aryl groups” refers to univalent functional groups derived from substituted arenes by removal of a hydrogen atom from a ring carbon atom. In this definition, the term “substituted arenes” refers to compounds derived from monocyclic and polycyclic aromatic hydrocarbons in which one or more of the hydrogen atoms of the hydrocarbon is replaced with a non-hydrogen atom (e.g., a halogen atom) or a non-alkyl functional group (e.g., a hydroxy group).

As used herein, the term “substituted heteroaryl groups” refers to univalent functional groups derived from substituted heteroarenes by removal of a hydrogen atom from a ring atom. In this definition, the term “substituted heteroarenes” refers to compounds derived from monocyclic and polycyclic aromatic hydrocarbons in which (1) one or more of the hydrogen atoms of the hydrocarbon is replaced with a non-hydrogen atom (e.g., a halogen atom) or a non-alkyl functional group (e.g., a hydroxy group) and (2) at least one methine group (—C═) of the hydrocarbon is replaced by a trivalent heteroatom and/or at least one vinylidene group (—CH═CH—) of the hydrocarbon is replaced by a divalent heteroatom.

As used herein, the term “alkanediyl groups” refers to divalent functional groups derived from alkanes by removal of two hydrogen atoms from the alkane. These hydrogen atoms can be removed from the same carbon atom on the alkane (as in ethane-1,1-diyl) or from different carbon atoms (as in ethane-1,2-diyl).

As used herein, the term “substituted alkanediyl groups” refers to divalent functional groups derived from substituted alkanes by removal of two hydrogen atoms from the alkane. These hydrogen atoms can be removed from the same carbon atom on the substituted alkane (as in 2-fluoroethane-1,1-diyl) or from different carbon atoms (as in 1-fluoroethane-1,2-diyl). In this definition, the term “substituted alkanes” has the same meaning as set forth above in the definition of substituted alkyl groups.

As used herein, the term “cycloalkanediyl groups” refers to divalent functional groups derived from cycloalkanes (monocyclic and polycyclic) by removal of two hydrogen atoms from the cycloalkane. These hydrogen atoms can be removed from the same carbon atom on the cycloalkane or from different carbon atoms.

As used herein, the term “substituted cycloalkanediyl groups” refers to divalent functional groups derived from substituted cycloalkanes by removal of two hydrogen atoms from the cycloalkane. In this definition, the term “substituted cycloalkanes” has the same meaning as set forth above in the definition of substituted cycloalkyl groups.

As used herein, the term “cycloalkenediyl groups” refers to divalent functional groups derived from cycloalkenes (monocyclic and polycyclic) by removal of two hydrogen atoms from the cycloalkene. These hydrogen atoms can be removed from the same carbon atom on the cycloalkene or from different carbon atoms.

As used herein, the term “substituted cycloalkenediyl groups” refers to divalent functional groups derived from substituted cycloalkenes by removal of two hydrogen atoms from the cycloalkene. These hydrogen atoms can be removed from the same carbon atom on the cycloalkene or from different carbon atoms. In this definition, the term “substituted cycloalkenes” has the same meaning as set forth above in the definition of substituted cycloalkene groups.

As used herein, the term “arenediyl groups” refers to divalent functional groups derived from arenes (monocyclic and polycyclic aromatic hydrocarbons) by removal of two hydrogen atoms from ring carbon atoms.

As used herein, the term “substituted arenediyl groups” refers to divalent functional groups derived from substituted arenes by removal of two hydrogen atoms from ring carbon atoms. In this definition, the term “substituted arenes” refers to compounds derived from monocyclic and polycyclic aromatic hydrocarbons in which one or more of the hydrogen atoms of the hydrocarbon is replaced with a non-hydrogen atom (e.g., a halogen atom) or a non-alkyl functional group (e.g., a hydroxy group).

As used herein, the term “heteroarenediyl groups” refers to divalent functional groups derived from heteroarenes by removal of two hydrogen atoms from ring atoms. In this definition, the term “heteroarenes” refers to compounds derived from monocyclic and polycyclic aromatic hydrocarbons in which at least one methine group (—C═) of the hydrocarbon is replaced by a trivalent heteroatom and/or at least one vinylidene group (—CH═CH—) of the hydrocarbon is replaced by a divalent heteroatom.

As used herein, the term “substituted heteroarenediyl groups” refers to divalent functional groups derived from substituted heteroarenes by removal of two hydrogen atoms from ring atoms. In this definition, the term “substituted heteroarenes” has the same meaning as set forth above in the definition of substituted heteroaryl groups.

Unless otherwise indicated, conditions are 25° C., 1 atmosphere of pressure and 50% relative humidity, concentrations are by weight, and molecular weight is based on weight average molecular weight. The term “polymer” as used in the present application denotes a material having a weight average molecular weight (M_{w}) of at least 5,000. The term “copolymer” is used in its broad sense to include polymers containing two or more different monomer units, such as terpolymers, and unless otherwise indicated, includes random, block, and statistical copolymers. The concentration of ethylene or propylene in a particular phase or in the heterophasic composition is based on the weight of reacted ethylene units or propylene units relative to the total weight of polyolefin polymer in the phase or heterophasic composition, respectively, excluding any fillers or other non-polyolefin additives. The concentration of each phase in the overall heterogeneous polymer composition is based on the total weight of polyolefin polymers in the heterophasic composition, excluding any fillers or other non-polyolefin additives or polymers. In the structures of functional groups set forth below, the truncated bonds (i.e., the bonds truncated by the wavy lines) represent bonds to other portions of the compound containing the illustrated group.

In a first embodiment, the invention provides a heterophasic polymer composition comprising (a) a propylene polymer phase, (b) an ethylene polymer phase, (c) a compatibilizing agent comprising a fulvene moiety, and (d) a nucleating agent.

In a second embodiment, the invention provides a method for modifying a heterophasic polymer composition. The method comprises the steps of (a) providing a compatibilizing agent, (b) providing a nucleating agent, (c) providing a heterophasic polymer composition comprising a propylene polymer phase and an ethylene polymer phase, (d) mixing the compatibilizing agent, the nucleating agent, and the heterophasic polymer composition, and (d) generating free radicals in the propylene polymer phase and the ethylene polymer phase. At least a portion of the compatibilizing agent then reacts with free radicals in both the propylene polymer phase and the ethylene polymer phase to form a bond with a propylene polymer in the propylene polymer phase and a bond with an ethylene polymer in the ethylene polymer phase.

The compatibilizing agent used in the composition and the method is an organic or organometallic compound comprising a fulvene moiety or a fulvene-derived moiety. The moiety can be unsubstituted or substituted, meaning that the hydrogens on the ring in the moiety and/or the terminal vinylic carbon atom can be replaced with non-hydrogen groups. Thus, in a preferred embodiment, the compatibilizing agent is selected from the group consisting of compounds comprising a moiety conforming to the structure of Formula (EI), compounds comprising a moiety conforming to the structure of Formula (EIII), and compounds conforming to the structure of Formula (EV)

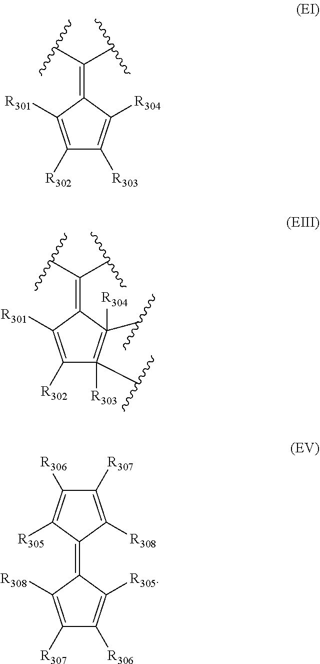

In the structures of Formula (EI) and Formula (EIII), R₃₀₁, R₃₀₂, R₃₀₃, and R₃₀₄ are independently selected from the group consisting of hydrogen, halogens, hydrocarbyl groups, and substituted hydrocarbyl groups, provided adjacent hydrocarbyl groups or substituted hydrocarbyl groups can be combined to form a secondary ring fused to the ring of the moiety. Further, at least one of R₃₀₁, R₃₀₂, R₃₀₃, and R₃₀₄ is a hydrogen; preferably, at least two of R₃₀₁, R₃₀₂, R₃₀₃, and R₃₀₄ are hydrogens. The truncated bonds (i.e., the bonds truncated by the wavy lines) attached to the terminal vinylic carbon atom (in both Formula (EI) and Formula (EIII)) and the adjacent carbon atoms in the ring (in Formula (EIII)) represent bonds to other portions of the compatibilizing agent. In the structure of Formula (EV), R₃₀₅, R₃₀₆, R₃₀₇, and R₃₀₈ are independently selected from the group consisting of halogens.

In a preferred embodiment, R₃₀₁, R₃₀₂, R₃₀₃, and R₃₀₄ are independently selected from the group consisting of hydrogen, halogens, alkyl groups, substituted alkyl groups, aryl groups, substituted aryl groups, heteroaryl groups, and substituted heteroaryl groups. Suitable alkyl groups include, but are not limited to, linear and branched C₁-C₁₈ alkyl groups. Suitable substituted alkyl groups include, but are not limited to, linear and branched C₁-C₁₈ alkyl groups substituted with one or more non-hydrogen groups selected from the group consisting of halogens, hydroxy, aryl groups, substituted aryl groups, heteroaryl groups, and substituted heteroaryl groups. Suitable aryl groups include, but are not limited to, aryl groups such as phenyl and naphthyl. Suitable substituted aryl groups include, but are not limited to, monocyclic and polycyclic aryl groups substituted with one or more non-hydrogen groups selected from the group consisting of halogens, hydroxy, alkyl groups, and substituted alkyl groups. Suitable heteroaryl groups include, but are not limited to, furyl, thienyl, pyrrolyl, imidazolyl, pyrazolyl, oxazolyl, pyridinyl, pyrazinyl, pyrimidinyl and benzannulated analogs of such groups, such as benzimidazolyl. Suitable substituted heteroaryl groups include, but are not limited to, the heteroaryl groups described immediately above substituted with one or more non-hydrogen groups selected from the group consisting of halogens, hydroxy, alkyl groups, and substituted alkyl groups. In another preferred embodiment, R₃₀₁, R₃₀₂, R₃₀₃, and R₃₀₄ are each hydrogens.

In a more specific embodiment, the compatibilizing agent can be a compound conforming to the structure of Formula (EX) below

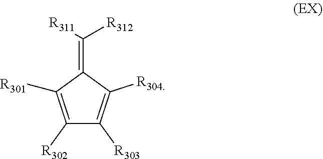

In the structure of Formula (EX), R₃₀₁, R₃₀₂, R₃₀₃, and R₃₀₄ are independently selected from the groups recited above for the structure of Formula (EI), and R₃₁₁ and R₃₁₂ are individual substituents independently selected from the group consisting of hydrogen, alkyl groups, substituted alkyl groups, alkenyl groups, substituted alkenyl groups, amine groups, substituted amine groups, aryl groups, substituted aryl groups, heteroaryl groups, and substituted heteroaryl groups or R₃₁₁ and R₃₁₂ together form a single substituent selected from the group consisting of aryl groups, substituted aryl groups, heteroaryl groups, and substituted heteroaryl groups. Preferably, no more than one of R₃₁₁ and R₃₁₂ can be hydrogen.

In a preferred embodiment, R₃₁₁ and R₃₁₂ are independently groups conforming to a structure selected from the group consisting of Formula (F), Formula (FX), and Formula (FXV)

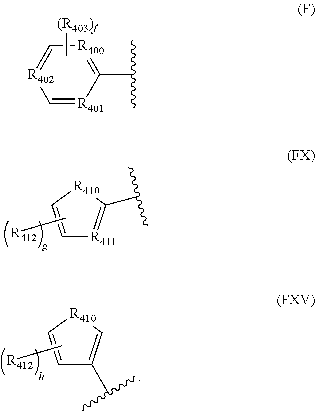

In the structure of Formula (F), R₄₀₀, R₄₀₁, and R₄₀₂ are independently selected from the group consisting of C(H), C(R₄₀₁), and a nitrogen atom. The variable f is an integer from 0 to 4, but does not exceed a value equal to 5-z, where z is the number of nitrogen atoms in the ring. Each R₄₀₁ is independently selected from the group consisting alkyl groups (e.g., C₁-C₁₀ alkyl groups), substituted alkyl groups (e.g., C₁-C₁₀ substituted alkyl groups), aryl groups (e.g., C₆C₁₂ aryl groups), substituted aryl groups (e.g., C₆C₁₂ substituted aryl groups), heteroaryl groups (e.g., C₄-C₁₂ heteroaryl groups), substituted heteroaryl groups (e.g., C₄-C₁₂ substituted heteroaryl groups), halogens, nitro groups, cyano groups, amine groups, hydroxy groups, alkoxy groups (e.g., C₁-C₁₀ alkoxy groups), aryloxy groups (e.g., C₆C₁₂ aryloxy groups), alkenyl groups (e.g., C₂-C₁₀ alkenyl groups), alkynyl groups (e.g., C₂-C₁₀ alkynyl groups), alkyl ester groups (e.g., C₁-C₁₀ alkyl ester groups), and aryl ester groups (e.g., C₆C₁₂ aryl ester groups). Further, two adjacent R₄₀₁ groups can be linked to form a fused ring structure, such as a polycyclic aryl group. In the structure of Formula (FX), R₄₁₀ is selected from the group consisting of an oxygen atom, a sulfur atom, and N(R₄₁₅). R₄₁₅ is selected from the group consisting of hydrogen, alkyl groups (e.g., C₁-C₁₀ alkyl groups), substituted alkyl groups (e.g., C₁-C₁₀ substituted alkyl groups), aryl groups (e.g., C₆C₁₂ aryl groups), and substituted aryl groups (e.g., C₆C₁₂ substituted aryl groups). R₄₁₁ is selected from the group consisting of C(H), C(R₁₁₂), and a nitrogen atom. R₄₁₂ is selected from the group consisting of alkyl groups (e.g., C₁-C₁₀ alkyl groups), substituted alkyl groups (e.g., C₁-C₁₀ substituted alkyl groups), aryl groups (e.g., C₆C₁₂ aryl groups), substituted aryl groups (e.g., C₆C₁₂ substituted aryl groups), heteroaryl groups (e.g., C₄-C₁₂ heteroaryl groups), substituted heteroaryl groups (e.g., C₄-C₁₂ substituted heteroaryl groups), halogens, nitro groups, cyano groups, amine groups, hydroxy groups, alkoxy groups (e.g., C₁-C₁₀ alkoxy groups), aryloxy groups (e.g., C₆C₁₂ aryloxy groups), alkenyl groups (e.g., C₁-C₁₀ alkenyl groups), alkynyl groups (e.g., C₂-C₁₀ alkynyl groups), alkyl ester groups (e.g., C₂-C₁₀ alkyl ester groups), and aryl ester groups (e.g., C₆C₁₂ aryl ester groups). Further, two adjacent R₄₁₂ groups can be linked to form a fused ring structure, such as a polycyclic aryl group. The variable g is an integer from 0 to 2. In the structure of Formula (FXV), R₄₁₀ and R₄₁₂ are selected from the same groups described above for Formula (FX), and the variable h is an integer from 0 to 3.

In a preferred embodiment, R₃₀₁, R₃₀₂, R₃₀₃, and R₃₀₄ are each hydrogen, and R₃₁₁ and R₃₁₂ are each a phenyl group. In another preferred embodiment, R₃₀₁, R₃₀₂, R₃₀₃, and R₃₀₄ are each hydrogen, and R₃₁₁ and R₃₁₂ are each a 4-chlorophenyl group. In another preferred embodiment, R₃₀₁, R₃₀₂, R₃₀₃, and R₃₀₄ are each hydrogen, and R₃₁₁ and R₃₁₂ are each a 4-fluorophenyl group. In another preferred embodiment, R₃₀₁, R₃₀₂, R₃₀₃, and R₃₀₄ are each hydrogen, R₃₁₁ is a methyl group, and R₃₁₂ is a phenyl. In another preferred embodiment, R₃₀₁, R₃₀₂, R₃₀₃, and R₃₀₄ are each hydrogen, R₃₁₁ is hydrogen, and R₃₁₂ is a 2-thienyl group. In another preferred embodiment, R₃₀₁, R₃₀₂, R₃₀₃, and R₃₀₄ are each hydrogen, R₃₁₁ is hydrogen, and R₃₁₂ is a 3-thienyl group. In another preferred embodiment, R₃₀₁, R₃₀₂, R₃₀₃, and R₃₀₄ are each hydrogen, R₃₁₁ is a methyl group, and R₃₁₂ is a 2-furyl group. In another preferred embodiment, R₃₀₁, R₃₀₂, R₃₀₃, and R₃₀₄ are each hydrogen, R₃₁₁ is hydrogen, and R₃₁₂ is a dimethylamino group. In another preferred embodiment, R₃₀₁, R₃₀₂, R₃₀₃, and R₃₀₄ are each hydrogen, and R₃₁₁ and R₃₁₂ are each C₁-C₈ alkyl groups, preferably propyl groups. In another preferred embodiment, R₃₀₁, R₃₀₂, R₃₀₃, and R₃₀₄ are each hydrogen, R₃₁₁ is hydrogen, and R₃₁₂ is a 2-phenylethenyl group.

The compatibilizing agent can comprise multiple fulvene moieties. For example, the compatibilizing agent can comprise two fulvene moieties and conform to the structure of Formula (EXX) below:

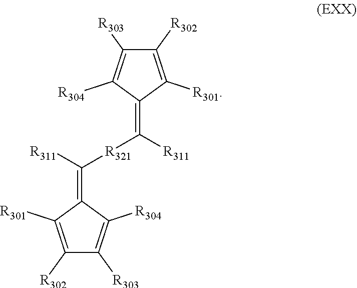

In the structure of Formula (EXX), each R₃₀₁, R₃₀₂, R₃₀₃, and R₃₀₄ is independently selected from the groups recited above in the structure of Formula (EI), each R₃₁₁ is independently selected from the group recited above in the structure of Formula (EX), and R₃₂₁ is selected from the group consisting of alkanediyl groups, substituted alkanediyl groups, arenediyl groups, substituted arenediyl groups, heteroarenediyl groups, and substituted heteroarenediyl groups. In a preferred embodiment, each R₃₀₁, R₃₀₂, R₃₀₃, and R₃₀₄ is hydrogen, each R₃₁₁ is an aromatic group, and R₃₂₁ is an arenediyl group. More specifically, in such a preferred embodiment, each R₃₀₁, R₃₀₂, R₃₀₃, and R₃₀₄ is hydrogen, each R₃₁₁ is a phenyl group, and R₃₂₁ is a phen-1,4-diyl group. In another preferred embodiment, each R₃₀₁, R₃₀₂, R₃₀₃, R₃₀₄, and R₃₁₁ is hydrogen, and R₃₂₁ is an arenediyl group, preferably a phen-1,4-diylgroup.

In certain instances, the compatibilizing agent can undergo a dimerization or oligomerization via an auto-Diels-Alder reaction. In such an auto-Diels-Alder reaction, the cyclopentadienyl moiety in one molecule of the compatibilizing agent acts as the diene, and a double bond in the cyclopentadienyl moiety of another molecule of the compatibilizing agent acts as the dienophile. When a fulvene moiety conforming to the structure of Formula (EI) is the dienophile in a Diels-Alder reaction, the fulvene moiety is transformed into a moiety conforming to the structure of Formula (EIII) above. In the structure of Formula (EIII) above, the truncated bonds attached to the adjacent carbon atoms in the ring represent bonds forming part of a cyclic moiety resulting from the reaction with the diene. Thus, in a more specific example of a compatibilizing agent comprising a moiety conforming to the structure of Formula (EIII) above, the compatibilizing agent can comprise a moiety conforming to the structure of Formula (EIIIA) below

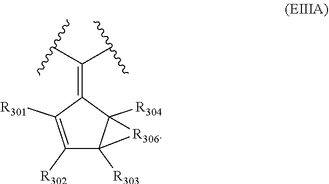

In the structure of Formula (EIIIA), R₃₀₁, R₃₀₂, R₃₀₃, and R₃₀₄ are selected from the groups recited above, and R₃₀₆ is a vicinal divalent moiety comprising at least one double bond, such as a divalent cyclic moiety (e.g., a divalent cyclopentenyl moiety). When R₃₀₆ is a divalent cyclic moiety (e.g., a divalent cyclopentenyl moiety), the compatibilizing agent comprises a bicyclic moiety formed by the bonds to adjacent carbon atoms in the cyclic moiety.

The dimer resulting from the auto-Diels-Alder reaction of a compatibilizing agent conforming to the structure of Formula (EX) above will conform to the structure of Formula (EXA) below

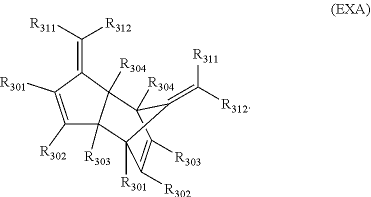

In the structure of Formula (EXA), R₃₀₁, R₃₀₂, R₃₀₃, R₃₀₄, R_{311,} and R₃₁₂ are selected from the groups disclosed above for the compound conforming to the structure of Formula (EX). The dimer can be either the endo or exo isomer. Further, a dimer possessing the structure of Formula (EXA) can serve as the dienophile in subsequent Diels-Alder reactions with a diene, with such subsequent reactions yielding a variety of oligomeric species. While not wishing to be bound to any particular theory, it is believed that the dimeric and oligomeric species described above can undergo a retro-Diels-Alder reaction to yield the fulvene-containing compounds from which the dimeric and oligomeric species were originally derived. It is believed that this retro-Diels-Alder reaction can occur when a polymer composition containing the dimeric or oligomeric species is heated during processing, such as the heating that occurs when the polymer composition is extruded.

The compatibilizing agent can have any suitable molar mass. As will be understood by those of ordinary skill in the art, the molar mass of a compound, in combination with other factors, influences the melting point and boiling point of a compound. Thus, compounds with higher molar masses generally have higher melting points and boiling points. While not wishing to be bound to any particular theory, it is believed that the melting point and boiling point of the compatibilizing agent may influence the efficacy of the compatibilizing agent in the compositions of the invention. For example, it is believed that a compatibilizing agent having a relatively low molar mass and low boiling point (e.g., a boiling point that is significantly lower than the temperature at which the polymer composition is extruded) may volatilize to a significant degree during the extrusion process, thereby leaving less compatibilizing agent to modify the properties of the polymer composition. Thus, the compatibilizing agent preferably has a molar mass that is high enough that the compatibilizing agent exhibits a boiling point that is greater than the temperature at which the polymer composition is extruded. In a series of preferred embodiments, the compatibilizing agent preferably has a molar mass of about 130 g/mol or more, about 140 g/mol or more, about 150 g/mol or more, or about 160 g/mol or more. Also, it is believed that a compatibilizing agent having a relatively high melting point (e.g., a melting point that is higher than the temperature at which the polymer composition is extruded) may not disperse well in the molten polymer during the extrusion process, or at least not disperse as well as a compatibilizing agent having a melting point below the extrusion temperature. And poor dispersion of the compatibilizing agent will negatively impact the physical property improvements that can be achieved as compared to a well-dispersed compatibilizing agent. Thus, in a series of preferred embodiments, the compatibilizing has a melting point of about 230° C. or less, about 220° C. or less, about 210° C. or less, or about 200° C. or less.

The concentration of the compatibilizing agent in the composition can be varied to meet the objectives of the end user. For example, the concentration can be varied in order to achieve a desired increase in the MFR of the polymer composition with a minimal decrease (or potentially even an increase) in the strength of the polymer, in particular the impact strength. In a preferred embodiment, the compatibilizing agent can be present in an amount of about 10 ppm or more, about 50 ppm or more, about 100 ppm or more, about 150 ppm or more, or about 200 ppm or more, based on the total weight of the polymer composition. In another preferred embodiment, the compatibilizing agent can be present in an amount of about 5 wt. % (50,000 ppm) or less, about 4 wt. % (40,000 ppm) or less, about 3 wt. % (30,000 ppm) or less, about 2 wt. % (20,000 ppm) or less, about 1 wt. % (10,000 ppm) or less, or about 0.5 wt. % (5,000 ppm) or less, based on the total weight of the polymer composition. Thus, in certain preferred embodiments, the compatibilizing agent can be present in an amount of about 10 to about 50,000 ppm, about 100 to about 10,000 ppm, or about 200 to about 5,000 ppm, based on the total weight of the polymer composition.

When a chemical free radical generator is employed (as discussed below), the concentration of the compatibilizing agent in the polymer composition can additionally or alternatively be expressed in terms of a ratio between the amount of the compatibilizing agent and the amount of the chemical free radical generator. In order to normalize this ratio for differences in the molecular weight of compatibilizing agents and number of peroxide bonds in the chemical free radical generators, the ratio is usual expressed as a ratio of the number of moles of compatibilizing agent present in the composition to the molar equivalents of peroxide bonds (O—O bonds) present from the addition of the chemical free radical generator. Preferably, the ratio (i.e., ratio of moles of compatibilizing agent to molar equivalents of peroxide bonds) is about 1:10 or more, about 1:5 or more, about 3:10 or more, about 2:5 or more, about 1:2 or more, about 3:5 or more, about 7:10 or more, about 4:5 or more, about 9:10 or more, or about 1:1 or more. In another preferred embodiment, the ratio is about 10:1 or less, about 5:1 or less, about 10:3 or less, about 5:2 or less, about 2:1 or less, about 5:3 or less, about 10:7 or less, about 5:4 or less, about 10:9 or less, or about 1:1 or less. Thus, in a series of preferred embodiments, the compatibilizing agent can be present in the composition in a ratio of moles of compatibilizing agent to molar equivalents of peroxide bonds of about 1:10 to about 10:1, about 1:5 to about 5:1, about 1:4 to about 4:1, about 3:10 to about 10:3, about 2:5 to about 5:2, or about 1:2 to about 2:1.

The composition comprises and one step of the method entails providing a nucleating agent. As utilized herein, the term “nucleating agent” refers to a substance that forms nuclei or provides sites for the formation and/or growth of crystals in a thermoplastic polymer as it solidifies from a molten state. Suitable nucleating agents include nucleating fillers (e.g., talc) and nucleating pigments.

Nucleating agents suitable for use in the composition and the method of the invention can comprise phosphate ester anions. Preferably, the phosphate ester anions conform to the structure of Formula (I) below

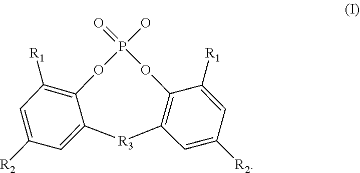

In the structure of Formula (I), R₁ and R₂ are independently selected from the group consisting of hydrogen and C₁-C₁₈ alkyl groups, and R₃ is an alkanediyl group. In a preferred embodiment, R₁ and R₂ are selected from the group consisting of hydrogen and C₁-C₄ alkyl groups. More preferably, R₁ and R₂ are tert-butyl groups. In a preferred embodiment, R₃ is a C₁-C₄ alkanediyl group. More preferably, R₃ is a methanediyl group. In a particularly preferred embodiment, the nucleating agent comprises 2,2′-methylene-bis-(4,6-di-tert-butylphenyl) phosphate anions, such as sodium 2,2′-methylene-bis-(4,6-di-tert-butylphenyl) phosphate or aluminum 2,2′-methylene-bis-(4,6-di-tert-butylphenyl)phosphate.

Nucleating agents suitable for use in the composition and the method of the invention can comprise aromatic carboxylate anions. Suitable aromatic carboxylate anions include, but are not limited to, benzoate anions and substituted benzoate anions (e.g., 4-tert-butylbenzoate anions). Thus, in a preferred embodiment, the nucleating agent can be sodium benzoate or aluminum 4-tert-butylbenzoate.

Nucleating agents suitable for use in the composition and the method of the invention can comprise cycloaliphatic dicarboxylate anions. Preferably, the cycloaliphatic dicarboxylate anions conform to a structure selected from the group consisting of Formula (X) and Formula (XX) below. The structure of Formula (X) is:

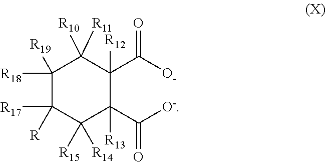

In the structure of Formula (X), R₁₀, R₁₁, R₁₂, R₁₃, R₁₄, R₁₅, R₁₆, R₁₇, R₁₈, and R₁₉ are independently selected from the group consisting of hydrogen, halogens, C₁-C₉ alkyl groups, C₁-C₉ alkoxy groups, and C₁-C₉ alkylamine groups. Preferably, R₁₀, R₁₁, R₁₂, R₁₃, R₁₄, R₁₅, R₁₆, R₁₇, R₁₈, and R₁₉ are each hydrogen. The two carboxylate moieties can be arranged in either the cis or the trans configuration. Preferably, the two carboxylate moieties are arranged in the cis configuration. In a specific preferred embodiment, R₁₀, R₁₁, R₁₂, R₁₃, R₁₄, R₁₅, R₁₆, R₁₇, R₁₈, and R₁₉ are each hydrogen, and the two carboxylate moieties are arranged in the cis configuration. The structure of Formula (XX) is:

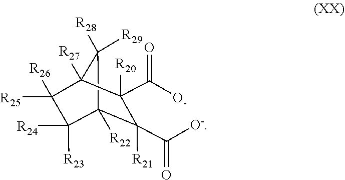

In the structure of Formula (XX), R₂₀, R₂₁, R₂₂, R₂₃, R₂₄, R₂₅, R₂₆, R₂₇, R₂₈, and R₂₉ are independently selected from the group consisting of hydrogen, halogens, C₁-C₉ alkyl groups, C₁-C₉ alkoxy groups, and C₁-C₉ alkylamine groups. In a preferred embodiment, R₂₀, R₂₁, R₂₂, R₂₃, R₂₄, R₂₅, R₂₆, R₂₇, R₂₈, and R₂₉ are each hydrogen.

The two carboxylate moieties can be arranged in either the cis or the trans configuration. Preferably, the two carboxylate moieties are arranged in the cis configuration. When arranged in the cis configuration, the two carboxylate moieties can be arranged in either the endo or exo configuration relative to the bicyclic portion of the compound. When the two carboxylate moieties are arranged in the cis configuration, the moieties preferably are arranged in the cis-endo configuration. In a preferred embodiment, the nucleating agent comprises bicyclo[2.2.1]heptane-2,3-dicarboxylate anions (e.g., disodium bicyclo[2.2.1]heptane-2,3-dicarboxylate and calcium bicyclo[2.2.1]heptane-2,3-dicarboxylate), cyclohexane-1,2-dicarboxylate anions (e.g., calcium cyclohexane-1,2-dicarboxylate, monobasic aluminum cyclohexane-1,2-dicarboxylate, dilithium cyclohexane-1,2-dicarboxylate, and strontium cyclohexane-1,2-dicarboxylate), and combinations thereof. As noted above, the bicyclo[2.2.1]heptane-2,3-dicarboxylate salts and the cyclohexane-1,2-dicarboxylate salts can have the two carboxylate moieties arranged in either the cis- or trans-configuration, with the cis-configuration being preferred.

The nucleating agent can be present in the heterophasic polymer composition in any suitable amount. As will be understood by those of ordinary skill in the art, the amount of nucleating agent suitable for use in the composition will depend upon several factors, such as the composition of the nucleating agent and the desired properties of the heterophasic polymer composition. For example, the nucleating agent can be present in the heterophasic polymer composition in an amount of about 0.01 wt. % or more, about 0.05 wt. % or more, about 0.075 wt. % or more, or about 0.1 wt. % or more, based on the total weight of the heterophasic polymer composition. The nucleating agent can be present in the heterophasic polymer composition in an amount of about 1 wt. % or less, about 0.5 wt. % or less, about 0.4 wt. % or less, or about 0.3 wt. % or less, based on the total weight of the heterophasic polymer composition. In certain possibly preferred embodiments, the nucleating agent is present in the heterophasic polymer composition in an amount of from about 0.01 to about 1 wt. %, about 0.05 to about 0.5 wt. %, about 0.075 to about 0.4 wt. %, or about 0.1 to about 0.3 wt. %, based on the total weight of the heterophasic polymer composition.

The composition comprises and one step of the method entails providing a heterophasic polymer composition. The heterophasic polymer composition preferably is a heterophasic polyolefin polymer composition. The subject heterophasic polyolefin polymers that can be advantageously modified according to the method of the invention are characterized by at least two distinct phases: a propylene polymer phase; and an ethylene polymer phase. The propylene polymer phase preferably comprises propylene polymers selected from the group consisting of polypropylene homopolymers and copolymers of propylene and up to 50 wt. % of ethylene and/or C₄-C₁₀ α-olefins. The ethylene polymer phase preferably comprises ethylene polymers selected from the group consisting of ethylene homopolymers and copolymers of ethylene and C₃-C₁₀ α-olefins. The ethylene content of the ethylene polymer phase preferably is at least 8 wt. %. When the ethylene phase is a copolymer of ethylene and C₃-C₁₀ α-olefins, the ethylene content of the ethylene phase can range from 8 to 90 wt. %. In one embodiment, the ethylene content of the ethylene phase preferably is at least 50 wt. %. Either the propylene polymer phase or the ethylene polymer phase can form the continuous phase of the composition and the other will form the discrete or dispersed phase of the composition. For example, the ethylene polymer phase can be the discontinuous phase and the polypropylene polymer phase can be the continuous phase. In one embodiment of the invention, the propylene content of the propylene polymer phase preferably is greater than the propylene content of the ethylene polymer phase.

The relative concentrations of the propylene polymer phase and the ethylene polymer phase in the heterophasic polymer composition can vary over a wide range. By way of example, the ethylene polymer phase can comprise from 5 to 80 wt. % of the total weight of propylene polymers and ethylene polymers in the composition, and the propylene polymer phase can comprise from 20 to 95 wt. % of the total weight of propylene polymers and ethylene polymers in the composition.

In various embodiments of the invention, (i) the ethylene content can range from 5 to 75 wt. %, or even 5 to 60 wt. %, based on the total propylene polymer and ethylene polymer content in the heterophasic composition, (ii) the ethylene polymer phase can be an ethylene-propylene or ethylene-octene elastomer, and/or (iii) the propylene content of the propylene polymer phase can be 80 wt. % or greater.

The method of the invention is particularly useful for modifying polypropylene impact copolymers. Suitable impact copolymers can be characterized by (i) a continuous phase comprising polypropylene polymers selected from the group consisting of polypropylene homopolymers and copolymers of propylene and up to 50 wt. % of ethylene and/or C₄-C₁₀ α-olefins and (ii) a discontinuous phase comprising elastomeric ethylene polymers selected from the group consisting of copolymers of ethylene and C₃-C₁₀ α-olefin monomers. Preferably, the ethylene polymers have an ethylene content of from 8 to 90 wt. %.

In various embodiments of the invention directed to propylene impact copolymers, (i) the ethylene content of the discontinuous phase can be from 8 to 80 wt. %, (ii) the ethylene content of the heterophasic composition can be from 5 to 30 wt. %, based on the total propylene polymers and ethylene polymers in the composition; (iii) the propylene content of the continuous phase can be 80 wt. % or greater and/or (iv) the discontinuous phase can be from 5 to 35 wt. % of the total propylene polymers and ethylene polymers in the composition.

Examples of heterophasic polyolefin polymers that can be modified are impact copolymers characterized by a relatively rigid, polypropylene homopolymer matrix (continuous phase) and a finely dispersed phase of ethylene-propylene rubber (EPR) particles. Such polypropylene impact copolymers can be made in a two-stage process, where the polypropylene homopolymer is polymerized first and the ethylene-propylene rubber is polymerized in a second stage. Alternatively, the impact copolymer can be made in three or more stages, as is known in the art. Suitable processes can be found in the following references: U.S. Pat. Nos. 5,639,822 and 7,649,052 B2. Examples of suitable processes to make polypropylene impact copolymers are known in the industry by the commercial names Spheripol®, Unipol®, Mitsui process, Novolen process, Spherizone®, Catalloy®, Chisso process, Innovene®, Borstar®, and Sinopec process. These processes could use heterogeneous or homogeneous Ziegler-Natta or metallocene catalysts to accomplish the polymerization.

The heterophasic polymer composition can be formed by melt mixing two or more polymer compositions, which form at least two distinct phases in the solid state. By way of example, the heterophasic composition can comprise three distinct phases. The heterophasic polymer composition can result from melt mixing two or more types of recycled polymer compositions (e.g., polyolefin polymer compositions). Accordingly, the phrase “providing a heterophasic polymer composition” as used herein includes employing a polymer composition in the process that is already heterophasic, as well as melt mixing two or more polymer compositions during the process, wherein the two or more polymer compositions form a heterophasic system. For example, the heterophasic polymer composition can be made by melt mixing a polypropylene homopolymer and an ethylene/α-olefin copolymer, such as an ethylene/butene elastomer. Examples of suitable ethylene/α-olefin copolymers are commercially available under the names Engage™, Exact®, Vistamaxx®, Versify™, INFUSE™, Nordel™, Vistalon®, Exxelor™, and Affinity™. Furthermore, it can be understood that the miscibility of the polymer components that form the heterophasic polymer composition can vary when the composition is heated above the melting point of the continuous phase in the system, yet the system will form two or more phases when it cools and solidifies. Examples of heterophasic polymer compositions can be found in U.S. Pat. No. 8,207,272 B2 and European Patent No. EP 1 391 482 B1.

Certain characteristics of the bulk heterophasic polymer composition (as measured prior to treatment with the compatibilizing agent) have been found to influence the physical property improvements (e.g., increase in impact strength) realized through the incorporation of the compatibilizing agent. In particular, with respect to the bulk characteristics of the heterophasic polymer composition, the ethylene preferably comprises about 6 wt. % or more, about 7 wt. % or more, about 8 wt. % or more, or about 9 wt. % or more of the total weight of the heterophasic polymer composition. The heterophasic polymer composition preferably contains about 10 wt. % or more, about 12 wt. % or more, about 15 wt. % or more, or about 16 wt. % or more xylene solubles or amorphous content. Further, about 5 mol. % or more, about 7 mol. % or more, about 8 mol. % or more, or about 9 mol. % or more of the ethylene present in the heterophasic polymer composition preferably is present in ethylene triads (i.e., a group of three ethylene monomer units bonded in sequence). Lastly, the number-average sequence length of ethylene runs (ethylene monomer units bonded in sequence) in the heterophasic polymer composition preferably is about 3 or more, about 3.25 or more, about 3.5 or more, about 3.75 or more, or about 4 or more. The mol. % of ethylene in ethylene triads and the number-average sequence length of ethylene runs can both be measured using ¹³C nuclear magnetic resonance (NMR) techniques known in the art. The heterophasic polymer composition can exhibit any one of the characteristics described in this paragraph. Preferably, the heterophasic polymer composition exhibits two or more of the characteristics described in this paragraph. Most preferably, the heterophasic polymer composition exhibits all of the characteristics described in this paragraph.

Certain characteristics of the ethylene phase of the heterophasic polymer composition (as measured prior to treatment with the compatibilizing agent) have also been found to influence the physical property improvements (e.g., increase in impact strength) realized through the incorporation of the compatibilizing agent. The characteristics of the ethylene phase of the composition can be measured using any suitable technique, such as temperature rising elution fractionation (TREF) and ¹³C NMR analysis of the fractions obtained. In a preferred embodiment, about 30 mol. % or more, about 40 mol. % or more, or about 50 mol. % or more of the ethylene present in a 60° C. TREF fraction of the heterophasic polymer composition is present in ethylene triads. In another preferred embodiment, about 30 mol. % or more, about 40 mol. % or more, or about 50 mol. % or more of the ethylene present in an 80° C. TREF fraction of the heterophasic polymer composition is present in ethylene triads. In another preferred embodiment, about 5 mol. % or more, about 10 mol. % or more, about 15 mol. % or more, or about 20 mol. % or more of the ethylene present in a 100° C. TREF fraction of the heterophasic polymer composition is present in ethylene triads. The number-average sequence length of ethylene runs present in a 60° C. TREF fraction of the heterophasic polymer composition preferably is about 3 or more, about 4 or more, about 5 or more, or about 6 or more. The number-average sequence length of ethylene runs present in an 80° C. TREF fraction of the heterophasic polymer composition preferably is about 7 or more, about 8 or more, about 9 or more, or about 10 or more. The number-average sequence length of ethylene runs present in a 100° C. TREF fraction of the heterophasic polymer composition preferably is about 10 or more, about 12 or more, about 15 or more, or about 16 or more. The heterophasic polymer composition can exhibit any one of the TREF fraction characteristics described above or any suitable combination of the TREF fraction characteristics described above. In a preferred embodiment, the heterophasic polymer composition exhibits all of the TREF fraction characteristics described above (i.e., the ethylene triad and number-average sequence length characteristics for the 60° C., 80° C., and 100° C. TREF fractions described above).

Heterophasic polymer compositions exhibiting the characteristics described in the two preceding paragraphs have been observed to respond more favorably to the addition of the compatibilizing agent than heterophasic polymer compositions that do not exhibit these characteristics. In particular, heterophasic polymer compositions exhibiting these characteristics show significant improvements in impact strength when processed according to the method of the invention, whereas heterophasic polymer compositions that do not exhibit these characteristics do not show such marked improvements when processed under the same conditions. This differential response and performance has been observed even when the different polymer compositions have approximately the same total ethylene content (i.e., the percent ethylene in each polymer composition is approximately the same). This result is surprising and was not anticipated.

In one embodiment of the invention, the heterophasic polymer composition does not have any polyolefin constituents with unsaturated bonds. In particular, both the propylene polymers in the propylene phase and the ethylene polymers in the ethylene phase are free of unsaturated bonds.

In another embodiment of the invention, in addition to the propylene polymer and ethylene polymer components, the heterophasic polymer composition can further comprise an elastomer, such as elastomeric ethylene copolymers, elastomeric propylene copolymers, styrene block copolymers, such as styrene-butadiene-styrene (SBS), styrene-ethylene-butylene-styrene (SEBS), styrene-ethylene-propylene-styrene (SEPS) and styrene-isoprene-styrene (SIS), plastomers, ethylene-propylene-diene terpolymers, LLDPE, LDPE, VLDPE, polybutadiene, polyisoprene, natural rubber, and amorphous polyolefins. The rubbers can be virgin or recycled.

As noted above, the method entails the step of mixing the compatibilizing agent and the heterophasic polymer composition. The compatibilizing agent and the heterophasic polymer composition can be mixed using any suitable technique or apparatus. In one embodiment of the invention, the heterophasic polymer composition is modified by melt mixing the polymer composition with a compatibilizing agent in the presence of free radicals, which have been generated in the composition. The melt mixing step is conducted under conditions such that the composition is heated to above the melting temperature of the major polyolefin component of the composition and mixed while in the molten state. Examples of suitable melt mixing processes include melt compounding, such as in an extruder, injection molding, and mixing in a Banbury mixer or kneader. By way of example, the mixture can be melt mixed at a temperature of from 160° C. to 300° C. In particular, propylene impact copolymers can be melt mixed at a temperature of from 180° C. to 290° C. The heterophasic polymer composition (propylene polymer phase and ethylene polymer phase), compatibilizing agent and an organic peroxide can be melt compounded in an extruder at a temperature above the melting temperature of all of the polyolefin polymers in the composition.

In another embodiment of the invention, the heterophasic polymer composition can be dissolved in a solvent, the compatibilizing agent can be added to the resulting polymer solution, and the free radicals can be generated in the solution. In another embodiment of the invention, the compatibilizing agent can be combined with the heterophasic polymer composition in the solid state and free radicals can be generated during solid-state shear pulverization as described in Macromolecules, “Ester Functionalization of Polypropylene via Controlled Decomposition of Benzoyl Peroxide during Solid-State Shear Pulverization”-vol. 46, pp. 7834-7844 (2013).

Conventional processing equipment may be used to mix the heterophasic polymer composition (e.g., propylene polymers and ethylene polymers) and compatibilizing agent together in a single step, in the presence of free radicals that are either added to the mixture, such as an organic peroxide, or generated in-situ, such as by shear, UV light, etc. Nevertheless, it is also possible to mix various combinations of the components in multiple steps and in various sequences, and subsequently subject the mixture to conditions whereby the compatibilizing agent reacts with the polyolefin polymers, as described herein.

For example, the compatibilizing agent and/or the free radical generator (when a chemical compound is used) can be added to the polymer in the form of one or masterbatch compositions. Suitable masterbatch compositions can comprise the compatibilizing agent and/or the free radical generator in a carrier resin. The compatibilizing agent and/or the free radical generator can be present in the masterbatch composition in an amount of about 1 wt. % to about 80 wt. % based on the total weight of the composition. Any suitable carrier resin can be used in the masterbatch compositions, such as any suitable thermoplastic polymer. For example, the carrier resin for the masterbatch compositions can be a polyolefin polymer, such as a polypropylene impact copolymer, a polyolefin copolymer, an ethylene/α-olefin copolymer, a polyethylene homopolymer, a linear low density polyethylene polymer, a polyolefin wax, or mixtures of such polymers. The carrier resin can also be a propylene polymer or an ethylene polymer that is the same as or similar to the propylene polymer or ethylene polymer present in the heterophasic polyolefin polymer composition. Such a masterbatch composition would allow the end user to manipulate the ratio of propylene polymer(s) to ethylene polymer(s) present in the heterophasic polymer composition. This may be preferred when the end user needs to modify the propylene to ethylene ratio of a commercial resin grade in order to achieve the desired set of properties (e.g., balance of impact and stiffness).

The method further comprises the step of generating free radicals in the resulting mixture of the compatibilizing agent and the heterophasic polymer composition. More specifically, this step involves generating free radicals in the propylene polymer phase and the ethylene polymer phase of the heterophasic polymer composition. The free radicals can be generated in the heterophasic polymer composition by any suitable means.

A free radical generator is employed in the present invention to cause polymer chain scission and thereby positively affect (i.e., increase) the MFR of the heterophasic polymer composition, while generating sufficient free radicals to foster the reaction of the compatibilizing agent with the propylene and ethylene polymers in the heterophasic polymer composition. The free radical generator can be a chemical compound, such as an organic peroxide or a bis-azo compound, or free radicals may be generated by subjecting the mixture of compatibilizing agent and heterophasic polymer composition to ultrasound, shear, an electron beam (for example β-rays), light (for example UV light), heat and radiation (for example γ-rays and X-rays), or combinations of the foregoing.

Organic peroxides having one or more O—O functionalities are of particular utility as the free radical generator in the method of the present invention. Examples of such organic peroxides include: 2,5-dimethyl-2,5-di(t-butylperoxy)hexane, 2,5-dimethyl-2,5-di(t-butyl peroxy)hexyne-3,3,6,6,9,9-pentamethyl-3-(ethyl acetate)-1,2,4,5-tetraoxy cyclononane, t-butyl hydroperoxide, hydrogen peroxide, dicumyl peroxide, t-butyl peroxy isopropyl carbonate, di-t-butyl peroxide, p-chlorobenzoyl peroxide, dibenzoyl diperoxide, t-butyl cumyl peroxide; t-butyl hydroxyethyl peroxide, di-t-amyl peroxide and 2,5-dimethylhexene-2,5-diperisononanoate, acetylcyclohexanesulphonyl peroxide, diisopropyl peroxydicarbonate, tert-amyl perneodecanoate, tert-butyl-perneodecanoate, tert-butylperpivalate, tert-amylperpivalate, bis(2,4-dichlorobenzoyl)peroxide, diisononanoyl peroxide, didecanoyl peroxide, dioctanoyl peroxide, dilauroyl peroxide, bis(2-methylbenzoyl)peroxide, disuccinoyl peroxide, diacetyl peroxide, dibenzoyl peroxide, tert-butyl per-2-ethylhexanoate, bis(4-chlorobenzoyl)peroxide, tert-butyl perisobutyrate, tert-butyl permaleate, 1,1-bis(tert-butylperoxy)-3,5,5-trimethylcyclo-hexane, 1,1-bis(tert-butylperoxy)cyclohexane, tert-butyl peroxyisopropyl carbonate, tert-butyl perisononaoate, 2,5-dimethylhexane 2,5-dibenzoate, tert-butyl peracetate, tert-amyl perbenzoate, tert-butyl perbenzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl)benzene, 3,5-bis(tert-butylperoxy)-3,5-dimethyl-1,2-dioxolane, di-tert-butyl peroxide, 2,5-dimethylhexyne 2,5-di-tert-butyl peroxide, 3,3,6,6,9,9-hexamethyl-1,2,4,5-tetraoxacyclononane, p-menthane hydroperoxide, pinane hydroperoxide, diisopropylbenzene mono-α-hydroperoxide, cumene hydroperoxide or tert-butyl hydroperoxide.

The organic peroxide can be present in the polymer composition in any suitable amount. The suitable amount of organic peroxide will depend upon several factors, such as the particular polymer that is used in the composition, the starting MFR of the heterophasic polymer composition, and the desired change in the MFR of the heterophasic polymer composition. In a preferred embodiment, the organic peroxide can be present in the polymer composition in an amount of about 10 ppm or more, about 50 ppm or more, or about 100 ppm or more, based on the total weight of the polymer composition. In another preferred embodiment, the organic peroxide can be present in the polymer composition in an amount of about 2 wt. % (20,000 ppm) or less, about 1 wt. % (10,000 ppm) or less, about 0.5 wt. % (5,000 ppm) or less, about 0.4 wt. % (4,000 ppm) or less, about 0.3 wt. % (3,000 ppm) or less, about 0.2 wt. % (2,000 ppm) or less, or about 0.1 wt. % (1,000 ppm) or less, based on the total weight of the polymer composition. Thus, in a series of preferred embodiments, the organic peroxide can be present in the polymer composition in an amount of about 10 to about 20,000 ppm, about 50 to about 5,000 ppm, about 100 to about 2,000 ppm, or about 100 to about 1,000 ppm, based on the total weight of the polymer composition. The amount of organic peroxide can also be expressed in terms of a molar ratio of the compatibilizing agent and peroxide bonds, as is described above.

Suitable bis azo compounds may also be employed as a source of free radicals. Such azo compounds include, for example, 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1′-azobis(1-cyclohexanecarbonitrile), 2,2′-azobis(isobutyramide)dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methyl-propane), 2,2′-azobis(N,N′-dimethyleneisobutyramidine) as free base or hydrochloride, 2,2′-azobis(2-amidinopropane) as free base or hydrochloride, 2,2′-azobis{2-methyl-N-[1,1-bis(hydroxymethyl)ethyl]propionamide}, and 2,2′-azobis{2-methyl-N-[1,1-bis(hydroxymethyl)-2-hydroxyethyl]propionamide}.

Other chemical compounds useful as free radical generators include 2,3-dimethyl-2,3-diphenylbutane and sterically hindered hydroxylamine ester. The various free radical generators described above may be employed alone or in combination.

As is generally described above, at least a portion of the free radicals generated in the propylene polymer phase and the ethylene polymer phase react with the reactive functional groups present on the compatibilizing agent. Specifically, the free radicals and the reactive functional groups react in a radical addition reaction thereby bonding the compatibilizing agent to the polymer. When the compatibilizing agent reacts with a free radical in the propylene polymer phase and a free radical in the ethylene polymer phase, the compatibilizing agent then provides a link or bridge between the two phases. While not wishing to be bound to any particular theory, it is believed that this link or bridge between the propylene polymer phase and the ethylene polymer phase is responsible for the increase in strength observed in heterophasic polymer compositions that have been modified according to the method of the invention.

The heterophasic polymer composition of the present invention is compatible with various types of additives conventionally used in thermoplastic compositions, including stabilizers, UV absorbers, hindered-amine light stabilizers (HALS), antioxidants, flame retardants, acid neutralizers, slip agents, antiblocking agents, antistatic agents, antiscratch agents, processing aids, blowing agents, colorants, opacifiers, clarifiers, and/or nucleating agents. By way of further example, the composition can comprise fillers, such as calcium carbonate, talc, glass fibers, glass spheres, inorganic whiskers such as Hyperform® HPR-803i available from Milliken Chemical, USA, magnesium oxysulfate whiskers, calcium sulfate whiskers, calcium carbonate whiskers, mica, wollastonite, clays, such as montmorillonite, and bio-sourced or natural filler. The additives can comprise up to 75 wt. % of the total components in the modified heterophasic polymer composition.

The heterophasic polymer composition of the present invention can be used in conventional polymer processing applications, including but not limited to injection molding, thin-wall injection molding, single-screw compounding, twin-screw compounding, Banbury mixing, co-kneader mixing, two-roll milling, sheet extrusion, fiber extrusion, film extrusion, pipe extrusion, profile extrusion, extrusion coating, extrusion blow molding, injection blow molding, injection stretch blow molding, compression molding, extrusion compression molding, compression blow forming, compression stretch blow forming, thermoforming, and rotomolding. Articles made using the heterophasic polymer composition of the invention can be comprised of multiple layers, with one or any suitable number of the multiple layers containing a heterophasic polymer composition of the invention. By way of example, typical end-use products include containers, packaging, automotive parts, bottles, expanded or foamed articles, appliance parts, closures, cups, furniture, housewares, battery cases, crates, pallets, films, sheet, fibers, pipe, and rotationally molded parts.

The following examples further illustrate the subject matter described above but, of course, should not be construed as in any way limiting the scope thereof. The following methods, unless noted, were used to determine the properties described in the following examples.

Each of the compositions was compounded by blending the components using either a Henschel high intensity mixer for about 2 minutes with a blade speed of about 2100 rpm or low intensity mixed in a closed container for approximately one minute.

The compositions were melt compounded using a Leistritz ZSE-18 co-rotating, fully intermeshing, parallel, twin-screw extruder with a 18 mm screw diameter and a length/diameter ratio of 40:1. The barrel temperature of the extruder was ranged from approximately 165° C. to approximately 175° C., the screw speed was set at approximately 500 rpm, the feed rate was 5 kg/hour resulting in a melt temperature of approximately 192° C. The extrudate (in the form of a strand) for each polypropylene composition was cooled in a water bath and subsequently pelletized.

The pelletized compositions were then used to form plaques and bars by injection molding on a 40 ton Arburg injection molder with a 25.4 mm diameter screw. 50 mils plaques were molded with the different samples at 230° C. barrel temperature, injection speed: 2.4 cc/sec, backpressure: 7 bars, cooling: 21° C., cycle time: 27 sec. Samples were submitted to DSC analysis.

ISO flex bars were molded at 210° C. barrel temperature, injection speed: 23.2 cc/sec, backpressure: 7 bars, cooling: 40° C., cycle time: 60.05 sec. The resulting bars measured approximately 80 mm long, approximately 10 mm wide, and approximately 4.0 mm thick. The bars were measured to determine their flexural modulus according to ISO method 178.

The notched Izod impact strength for the bars was measured according to ISO method 180/A. The notched Izod impact strength was measured at +23° C. on bars that had been conditioned at +23° C. For certain samples, notched Izod impact strength was also measured at 0° C.

Differential scanning calorimetry was performed following ASTM E794 to measure Peak T_{c} and ΔH of crystallization. DSC was measured using a Mettler Toledo DSC 700 with Perkin Elmer vented pans and lids. Briefly, an approximately 2.1 to 2.2 mg sample is heated from 50° C. to 220° C. at 20° C./minute until the sample reaches 220° C. The sample is then held at 220° C. for 2 minutes to ensure complete melting before cooling to 50° C. at 20° C./minute. The difference in energy between the sample and an empty control pan is measured on both the heating and cooling.

### EXAMPLE 1

The following example demonstrates the modification of a heterophasic polyolefin composition and performance enhancements achieved according to the present invention.

Twelve heterophasic polymer compositions were produced as described in Tables 1 and 2, below

TABLE 1
Heterophasic polypropylene copolymer formulations.

| Component | Loading | |
|---|---|---|
| Polypropylene copolymer (Prime Polymer J707P) | Balance | |
| Impact Modifier (Engage 8137) | 5 | wt % |
| Peroxide (Varox DBPH) | See Table 2 | |
| Stabilizer 1 (Irganox ® 1010) | 500 | ppm |
| Stabilizer 2 (Irgaphos ® 168) | 1000 | ppm |

| | |
|---|---|
| Acid Scavenger (DHT-4V) | See Table 2 |
| Nucleating agent | See Table 2 |
| Compatibilizing Agent | See Table 2 |

The polypropylene copolymer used in these examples is Prime Polymer J707P, with a rubber content of approximately 14.5%. Irganox® 1010 is a primary antioxidant available from BASF. Irgafos® 168 is a secondary antioxidant available from BASF. DHT-4V is a hydrotalcite available from Kisuma Chemicals. Varox DBPH is an organic peroxide available from R.T. Vanderbilt Company. The nucleating agents used in making these samples were are sodium benzoate (N.A. 1), sodium 2,2′ methylene bis-(4,6-di-tert-butylphenyl) phosphate (N.A. 2), and a nucleating agent containing a mixture of sodium benzoate and aluminum 2,2′ methylene bis (4,6-di-tert-butylphenyl)phosphate (N.A. 3). The compatibilizing agent (C.A. 1) is a compound of Formula (EX) above in which R₃₀₁, R₃₀₂, R₃₀₃, and R₃₀₄ are each hydrogen and R₃₁₁ and R₃₁₂ are each phenyl.

Each of the compositions listed in Tables 1 and 2 were mixed, extruded, and injection molded according to the procedure described above. The resulting pellets were subjected to melt flow rate testing and the bars were tested for impact strength, flexural modulus and thermal properties as described above.

TABLE 2
Heterophasic polypropylene copolymer formulations.

| | | | | | Varox | |
|---|---|---|---|---|---|---|
| | DHT-4V | N.A. 1 | N.A. 2 | N.A. 3 | DBPH | C.A. 1 |
| Sample | (ppm) | (ppm) | (ppm) | (ppm) | (ppm) | (ppm) |
| C.S. 1A | 400 | | | | 150 | |
| C.S. 1B | 400 | | | | 800 | 1200 |
| C.S. 2 | | 1000 | | | 150 | |
| 2 | | 1000 | | | 800 | 1200 |
| C.S. 3 | 400 | | 1000 | | 150 | |
| 3 | 400 | | 1000 | | 800 | 1200 |
| C.S. 4 | 400 | | | 500 | 150 | |
| 4 | 400 | | | 500 | 800 | 1200 |
| C.S. 5 | 400 | | | 1000 | 150 | |
| 5 | 400 | | | 1000 | 800 | 1200 |

TABLE 3
Mechanical and thermal properties of formulations.

| | | | | | RT | | Increase |
|---|---|---|---|---|---|---|---|
| | | | | Chord | Notched | | in impact |
| | MFR | T_{c} | ΔH | Modulus | Izod | Failure | strength |
| Sample | (g/10 min) | (° C.) | (J/g) | (MPa) | (kJ/m²) | Type | (%) |
| C.S. 1A | 61 | 117 | 94.2 | 1014 | 7.0 | Complete | |
| C.S. 1B | 63 | 118 | 90.5 | 983 | 10.0 | Complete | 43 |
| C.S. 2 | 69 | 125 | 87.1 | 1134 | 7.2 | Complete | |
| 2 | 41 | 127 | 97.1 | 1120 | 12.1 | Complete | 68 |
| C.S. 3 | 70 | 128 | 91.0 | 1215 | 7.1 | Complete | |
| 3 | 47 | 128 | 99.8 | 1173 | 15.6 | Complete | 120 |
| C.S. 4 | 61 | 129 | 89.2 | 1279 | 6.7 | Complete | |
| 4 | 44 | 128 | 95.0 | 1194 | 34.5 | Partials | 414 |
| C.S. 5 | 44 | 129 | 93.4 | 1335 | 6.8 | Complete | |
| 5 | 38 | 128 | 99.0 | 1222 | 34.8 | Partials | 413 |

The data in Table 3 shows that adding the nucleating agent to the resin results in an increase in the stiffness (Chord Modulus). The magnitude of stiffness improvement is dependent on the nucleating agent used, with a weaker nucleating agent (N.A. 1) providing less of an improvement and a stronger nucleating agent (e.g., N.A. 2 or N.A. 3) providing more of an improvement. However, none of the samples containing only a nucleating agent exhibited an increase in the impact resistance. Indeed, C.S. 4 and C.S. 5 actually showed a decrease in the impact resistance as compared to C.S. 1A.

The addition of a compatibilizing agent results in an increase in the impact strength as shown by a comparison of C.S. 1A and C.S. 1B. The magnitude of the increase is approximately 42%. Surprisingly, the samples containing both the compabtilizing agent and the nucleating agent exhibited even greater increases in impact strength as is shown in Table 3. Comparing C.S. 2 to Sample 2, C.S. 3 to Sample 3, C.S. 4 to Sample 4, and C.S. 5 to Sample 5 the impact strengths increase by 68%, 120%, 413%, and 414%, respectively. In addition, Samples 4 and 5 now exhibit the desirable partial failures indicating a change in failure mechanism from brittle to ductile as compared to C.S. 4 and C.S. 5. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 2

The following example demonstrates the modification of a heterophasic polyolefin composition and performance enhancements achieved according to the present invention.

Six heterophasic polymer compositions were produced. The general formulation for these samples is set forth in Table 4.

TABLE 4
Heterophasic polypropylene copolymer formulations.

| Component | Loading | |
|---|---|---|
| Polypropylene copolymer (Prime Polymer J707P) | Balance | |
| Impact Modifier (Engage 8137) | 5 | wt % |
| Peroxide (Varox DBPH) | See Table 5 | |
| Stabilizer 1 (Irganox ® 1010) | 500 | ppm |
| Stabilizer 2 (Irgaphos ® 168) | 1000 | ppm |
| Acid Scavenger (DHT-4V) | 400 | ppm |

| | |
|---|---|
| Nucleating agent | See Table 5 |
| Compatibilizing Agent | See Table 5 |

The nucleating agent used in making the samples was aluminum 2,2′-methylene-bis-(4,6-di-tert-butylphenyl)phosphate available from two different commercial sources (N.A. 4 and N.A. 5). The compatibilizing agent was C.A. 1 from Example 1.

Each of the compositions listed in Tables 4 and 5 were mixed, extruded, and injection molded according to the procedure described above. The resulting pellets were subjected to melt flow rate testing and the bars were tested for impact strength, flexural modulus and thermal properties as described above.

TABLE 5
Heterophasic polypropylene copolymer formulations.

| | | | Varox | |
|---|---|---|---|---|
| | N.A. 4 | N.A. 5 | DBPH | C.A. 1 |
| Sample | (ppm) | (ppm) | (ppm) | (ppm) |
| C.S. 6A | | | | |
| C.S. 6B | | | 100 | |
| C.S. 6C | | | 800 | 1200 |
| C.S. 7 | 1000 | | 100 | |
| 7 | 1000 | | 800 | 1200 |
| C.S. 8 | | 1000 | 100 | |
| 8 | | 1000 | 800 | 1200 |

TABLE 6
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 6A | 27 | 121 | 79.9 | 1140 | 8.3 | Complete | |
| C.S. 6B | 49 | 120 | 84.9 | 1095 | 7.2 | Complete | |
| C.S. 6C | 63 | 121 | 91.2 | 1080 | 12.1 | Complete | 31 |
| C.S. 7 | 49 | 130 | 84.6 | 1328 | 7.7 | Complete | |
| 7 | 55 | 129 | 87.8 | 1248 | 14.3 | Complete | 86 |
| C.S. 8 | 49 | 128 | 87.2 | 1286 | 8.1 | Complete | |
| 8 | 53 | 128 | 81.4 | 1208 | 35.6 | Partials | 340 |

C.S. 6A is the resin without the addition of peroxide and shows the lowest MFR and moderate stiffness. When peroxide is added (C.S. 6B), the MFR increases, and the stiffness and impact resistance both decrease. The addition of the compatibilizing agent (C.S. 6C) with additional peroxide shows an increase in the impact resistance with a slight further decrease in the stiffness. The addition of the nucleating agent with the peroxide (C.S. 7 and C.S. 8) shows an increase in the stiffness, but the impact resistance remains less than the virgin resin (C.S. 6A).

The addition of the compatibilizing agent results in an increase in the impact strength as shown by a comparison of C.S. 6B and C.S. 6C. The magnitude of the increase is approximately 31%. Surprisingly, the samples containing both the compabtilizing agent and the nucleating agent exhibited even greater increases in impact strength as is shown in Table 6. Comparing C.S. 7 to Sample 7 and C.S. 8 to Sample 8, the impact strengths increase by 86% and 340%, respectively. In addition, Sample 8, now exhibits the desirable partial failures indicating a change in failure mechanism from brittle to ductile compared to C.S. 8. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 3

The following example demonstrates the modification of a heterophasic polyolefin composition and performance enhancements achieved according to the method of the present invention.

Twelve heterophasic polymer compositions were produced. The general formulation for these samples is set forth in Table 7.

TABLE 7
Heterophasic polypropylene copolymer formulations.

| Component | Loading | |
|---|---|---|
| Polypropylene copolymer (Prime Polymer J707P) | Balance | |
| Impact Modifier (Engage 8137) | 5 | wt % |
| Peroxide (Varox DBPH) | See Table 8 | |
| Stabilizer 1 (Irganox ® 1010) | 500 | ppm |
| Stabilizer 2 (Irgaphos ® 168) | 1000 | ppm |
| Acid Scavenger (DHT-4V) | 400 | ppm |

| | |
|---|---|
| Nucleating agent | See Table 8 |
| Compatibilizing Agent | See Table 8 |

Each of the compositions listed in Tables 7 and 8 were mixed, extruded, and injection molded according to the above procedure. The resulting pellets were subjected to melt flow rate testing and the bars were tested for impact strength, flexural modulus and thermal properties as described above.

The nucleating agents used in making the samples were a talc (Jetfine 3CA available from Imerys) (N.A. 6), aluminum 4-tert-butylbenzoate (N.A. 7), a nucleating agent containing calcium cis-cyclohexane-1,2-dicarboxylate (N.A. 8), a nucleating agent containing a mixture of disodium bicyclo[2.2.1]heptane-2,3-dicarboxylate and sodium 2,2′ methylene bis-(4,6-di-tert-butylphenyl) phosphate (N.A. 9), and disodium bicyclo[2.2.1]heptane-2,3-dicarboxylate (N.A. 10).

TABLE 8
Heterophasic polypropylene copolymer formulations.

| | | | | | | Varox | |
|---|---|---|---|---|---|---|---|
| | N.A. 6 | N.A. 7 | N.A. 8 | N.A. 9 | N.A. 10 | DBPH | C.A. 1 |
| Sample | (ppm) | (ppm) | (ppm) | (ppm) | (ppm) | (ppm) | (ppm) |
| C.S. 9A | | | | | | | |
| C.S. 9B | | | | | | 800 | 1200 |
| C.S. 10 | 1000 | | | | | 100 | |
| 10 | 1000 | | | | | 800 | 1200 |
| C.S. 11 | | 1000 | | | | 100 | |
| 11 | | 1000 | | | | 800 | 1200 |
| C.S. 12 | | | 1000 | | | 100 | |
| 12 | | | 1000 | | | 800 | 1200 |
| C.S. 13 | | | | 1000 | | 100 | |
| 13 | | | | 1000 | | 800 | 1200 |
| C.S. 14 | | | | | 1000 | 100 | |
| 14 | | | | | 1000 | 800 | 1200 |

TABLE 9
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 9A | 26 | 118 | 87.2 | 1084 | 8.2 | Complete | |
| C.S. 9B | 72 | 118 | 84.3 | 1036 | 10.1 | Complete | 23 |
| C.S. 10 | 42 | 119 | 92.1 | 1098 | 8.1 | Complete | |
| 10 | 44 | 118 | 89.2 | 1056 | 14.6 | Complete | 80 |
| C.S. 11 | 49 | 128 | 92.4 | 1239 | 7.7 | Complete | |
| 11 | 49 | 128 | 89.9 | 1166 | 13.7 | Complete | 78 |
| C.S. 12 | 49 | 126 | 85.1 | 1233 | 8.0 | Complete | |
| 12 | 54 | 125 | 90.0 | 1160 | 17.4 | Complete | 118 |
| C.S. 13 | 49 | 129 | 84.5 | 1289 | 8.4 | Complete | |
| 13 | 51 | 128 | 89.7 | 1206 | 35.8 | Partials | 326 |
| C.S. 14 | 51 | 127 | 90.1 | 1174 | 8.7 | Complete | |
| 14 | 52 | 127 | 85.2 | 1136 | 15.3 | Complete | 76 |

The data in Table 9 shows that adding the nucleating agent to the resin results in an increase in the stiffness (Chord Modulus). The magnitude of stiffness improvement is dependent on the nucleating agent used. However, none of the samples containing only a nucleating agent exhibited an increase in the impact resistance. Indeed, C.S. 11 and C.S. 12 actually showed a decrease in the impact resistance as compared to C.S. 9A.

The addition of a compatibilizing agent results in an increase in the impact strength as shown by a comparison of C.S. 9A and C.S. 9B. The magnitude of the increase is approximately 23%. Surprisingly, the samples containing both the compabtilizing agent and the nucleating agent exhibited even greater increases in impact strength as is shown in Table 9. Comparing C.S. 10 to Sample 10, C.S. 11 to Sample 11, C.S. 12 to Sample 12, C.S. 13 to Sample 13 and C.S. 14 to Sample 14, the impact strengths increased by 80%, 78%, 118%, 326%, and 76%, respectively. In addition, Sample 13, now exhibits the desirable partial failures indicating a change in failure mechanism from brittle to ductile compared to C.S. 13. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 4

The following example demonstrates the modification of a heterophasic polyolefin composition and performance enhancements achieved according to the present invention using a different type of impact modifier than the one used in the previous examples.

Ten heterophasic polymer compositions were produced. The general formulation for these samples is set forth in Table 10.

TABLE 10
Heterophasic polypropylene copolymer formulations.

| Component | Loading | |
|---|---|---|
| Polypropylene copolymer (Prime Polymer J707P) | Balance | |
| Impact Modifier (Engage 8200) | 5 | wt % |
| Peroxide (Varox DBPH) | See Table 11 | |
| Stabilizer 1 (Irganox ® 1010) | 500 | ppm |
| Stabilizer 2 (Irgaphos ® 168) | 1000 | ppm |
| Acid Scavenger (DHT-4V) | 400 | ppm |

| | |
|---|---|
| Nucleating agent | See Table 11 |
| Compatibilizing Agent | See Table 11 |

Each of the compositions listed in Tables 10 and 11 were mixed, extruded, and injection molded according to the above procedure. The resulting pellets were subjected to melt flow rate testing and the bars were tested for impact strength, flexural modulus and thermal properties as described above.

TABLE 11
Heterophasic polypropylene copolymer formulations.

| | | | | | Varox | |
|---|---|---|---|---|---|---|
| | N.A. 5 | N.A. 2 | N.A. 3 | N.A. 9 | DBPH | C.A. 1 |
| Sample | (ppm) | (ppm) | (ppm) | (ppm) | (ppm) | (ppm) |
| C.S. 15A | | | | | 100 | |
| C.S. 15B | | | | | 800 | 1200 |
| C.S. 16 | 1000 | | | | 100 | |
| 16 | 1000 | | | | 800 | 1200 |
| C.S. 17 | | 1000 | | | 100 | |
| 17 | | 1000 | | | 800 | 1200 |
| C.S. 18 | | | 1000 | | 100 | |
| 18 | | | 1000 | | 800 | 1200 |
| C.S. 19 | | | | 1000 | 100 | |
| 19 | | | | 1000 | 800 | 1200 |

TABLE 12
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 15A | 49 | 117 | 88.5 | 1017 | 7.9 | Complete | |
| C.S. 15B | 52 | 119 | 87.7 | 1062 | 11.7 | Complete | 48 |
| C.S. 16 | 43 | 127 | 89.1 | 1273 | 8.0 | Complete | |
| 16 | 48 | 126 | 89.5 | 1193 | 18.3 | Complete | 129 |
| C.S. 17 | 41 | 128 | 72.2 | 1300 | 8.0 | Complete | |
| 17 | 48 | 128 | 90.5 | 1203 | 13.7 | Complete | 71 |
| C.S. 18 | 40 | 129 | 93.7 | 1390 | 8.1 | Complete | |
| 18 | 42 | 129 | 91.7 | 1287 | 16.1 | Complete | 99 |
| C.S. 19 | 40 | 130 | 88.7 | 1303 | 8.1 | Complete | |
| 19 | 41 | 129 | 91.4 | 1232 | 16.7 | Complete | 106 |

The data in Table 12 again shows that adding the nucleating agent (in the absence of the compatibilizing agent) results in an increase in the stiffness (Chord Modulus) with little to no effect on the impact resistance. The addition of a compatibilizing agent results in an increase in the impact strength as shown by a comparison of C.S. 15A and C.S. 15B. The magnitude of the increase is approximately 48%. Surprisingly, the samples containing both the compabtilizing agent and the nucleating agent exhibited even greater increases in impact strength as is shown in Table 12. Comparing C.S. 16 to Sample 16, C.S. 17 to Sample 17, C.S. 18 to Sample 18 and C.S. 19 to Sample 19, the impact strengths increased by 129%, 71%, 99% and 106%, respectively. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 5

The following example demonstrates the modification of a heterophasic polyolefin composition and performance enhancements achieved according to the method of the present invention using a yet another impact modifier.

Ten heterophasic polymer compositions were produced. The general formulation for these samples is set forth in Table 13.

TABLE 13
Heterophasic polypropylene copolymer formulations.

| Component | Loading | |
|---|---|---|
| Polypropylene copolymer (Prime Polymer J707P) | Balance | |
| Impact Modifier (Engage 7447) | 5 | wt % |
| Peroxide (Varox DBPH) | See Table 14 | |
| Stabilizer 1 (Irganox ® 1010) | 500 | ppm |
| Stabilizer 2 (Irgaphos ® 168) | 1000 | ppm |
| Acid Scavenger (DHT-4V) | 400 | ppm |

| | |
|---|---|
| Nucleating agent | See Table 14 |
| Compatibilizing Agent | See Table 14 |

Each of the compositions listed in Tables 13 and 14 were mixed, extruded, and injection molded according to the above procedure. The resulting pellets were subjected to melt flow rate testing and the bars were tested for impact strength, flexural modulus and thermal properties as described above.

TABLE 14
Heterophasic polypropylene copolymer formulations.

| | | | | | Varox | |
|---|---|---|---|---|---|---|
| | N.A. 5 | N.A. 2 | N.A. 3 | N.A. 9 | DBPH | C.A. 1 |
| Sample | (ppm) | (ppm) | (ppm) | (ppm) | (ppm) | (ppm) |
| C.S. 20A | | | | | 100 | |
| C.S. 20B | | | | | 800 | 1200 |
| C.S. 21 | 1000 | | | | 100 | |
| 21 | 1000 | | | | 800 | 1200 |
| C.S. 22 | | 1000 | | | 100 | |
| 22 | | 1000 | | | 800 | 1200 |
| C.S. 23 | | | 1000 | | 100 | |
| 23 | | | 1000 | | 800 | 1200 |
| C.S. 24 | | | | 1000 | 100 | |
| 24 | | | | 1000 | 800 | 1200 |

TABLE 15
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 20A | 58 | 117 | 89.0 | 1061 | 8.3 | Complete | |
| C.S. 20B | 56 | 119 | 91.8 | 1064 | 11.4 | Complete | 37 |
| C.S. 21 | 56 | 126 | 85.6 | 1269 | 8.6 | Complete | |
| 21 | 52 | 126 | 92.1 | 1192 | 18.0 | Complete | 109 |
| C.S. 22 | 56 | 128 | 92.9 | 1280 | 8.2 | Complete | |
| 22 | 66 | 128 | 82.5 | 1216 | 11.9 | Complete | 45 |
| C.S. 23 | 50 | 129 | 97.5 | 1359 | 8.2 | Complete | |
| 23 | 55 | 129 | 87.6 | 1272 | 34.5 | Partial | 321 |
| C.S. 24 | 50 | 129 | 96.1 | 1292 | 8.0 | Complete | |
| 24 | 42 | 128 | 94.7 | 1223 | 35.7 | Partial | 346 |

The data in Table 15 shows that adding the nucleating agent (in the absence of the compatibilizing agent) results in an increase in the stiffness (Chord Modulus) with little to no effect on the impact resistance. The addition of a compatibilizing agent results in an increase in the impact strength as shown by a comparison of C.S. 20A and C.S. 20B. The magnitude of the increase is approximately 37%. Surprisingly, the samples containing both the compabtilizing agent and the nucleating agent exhibited even greater increases in impact strength as is shown in Table 15. Comparing C.S. 21 to Sample 21, C.S. 22 to Sample 22, C.S. 23 to Sample 23 and C.S. 24 to Sample 24, the impact strengths increased by 109%, 45%, 321% and 346%, respectively. In addition, Samples 23 and 24 now exhibit the desirable partial failures indicating a change in failure mechanism from brittle to ductile compared to C.S. 23 and C.S. 24. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 6

The following example demonstrates the modification of a heterophasic polyolefin composition and performance enhancements achieved according to the present invention using three different types of impact modifiers.

Twelve heterophasic polymer compositions were produced. The general formulation for these samples is set forth in Table 16.

TABLE 16
Heterophasic polypropylene copolymer formulations.

| Component | Loading |
|---|---|
| Polypropylene copolymer (Prime Polymer J707P) | Balance |
| Impact Modifier (three different types) | See Table 17 |
| Peroxide (Varox DBPH) | See Table 17 |
| Stabilizer 1 (Irganox ® 1010) | 500 ppm |
| Stabilizer 2 (Irgaphos ® 168) | 1000 ppm |
| Acid Scavenger (DHT-4V) | 400 ppm |
| Nucleating agent (N.A. 3) | See Table 17 |
| Compatibilizing Agent | See Table 17 |

Each of the compositions listed in Tables 16 and 17 were mixed, extruded, and injection molded according to the above procedure. The resulting pellets were subjected to melt flow rate testing and the bars were tested for impact strength, flexural modulus and thermal properties as described above.

TABLE 17
Heterophasic polypropylene copolymer formulations.

| | Vistamaxx | Kraton | Infuse | | Varox | |
|---|---|---|---|---|---|---|
| | 6202 | G1642 | 9817 | N.A. 3 | DBPH | C.A. 1 |
| Sample | (%) | (%) | (%) | (ppm) | (ppm) | (ppm) |
| C.S. 25A | 5 | | | | 100 | |
| C.S. 25B | 5 | | | | 800 | 1200 |
| C.S. 26 | 5 | | | 1000 | 100 | |
| 26 | 5 | | | 1000 | 800 | 1200 |
| C.S. 27A | | 5 | | | 100 | |
| C.S. 27B | | 5 | | | 800 | 1200 |
| C.S. 28 | | 5 | | 1000 | 100 | |
| 28 | | 5 | | 1000 | 800 | 1200 |
| C.S. 29A | | | 5 | | 100 | |
| C.S. 29B | | | 5 | | 800 | 1200 |
| C.S. 30 | | | 5 | 1000 | 100 | |
| 30 | | | 5 | 1000 | 800 | 1200 |

TABLE 18
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 25A | 52 | 116.5 | 92.8 | 938 | 8.1 | Complete | |
| C.S. 25B | 61 | 118.0 | 121.3 | 961 | 10.3 | Complete | 27 |
| C.S. 26 | 42 | 129.0 | 132.8 | 1274 | 9.0 | Complete | |
| 26 | 51 | 128.5 | 105.0 | 1177 | 35.1 | Partial | 290 |
| C.S. 27A | 45 | 118.3 | 91.7 | 1012 | 9.7 | Complete | |
| C.S. 27B | 58 | 116.7 | 115.4 | 945 | 13.5 | Complete | 39 |
| C.S. 28 | 40 | 129.2 | 113.5 | 1301 | 9.7 | Complete | |
| 28 | 43 | 128.5 | 121.7 | 1207 | 34.6 | Partial | 256 |
| C.S. 29A | 49 | 117.5 | 96.2 | 1074 | 7.8 | Complete | |
| C.S. 29B | 58 | 116.3 | 121.0 | 979 | 11.5 | Complete | 47 |
| C.S. 30 | 44 | 129.0 | 116.1 | 1373 | 8.1 | Complete | |
| 30 | 45 | 128.5 | 128.5 | 1240 | 37.4 | Partial | 362 |

The data in Table 18 shows that adding the nucleating agent (in the absence of the compatibilizing agent) results in an increase in the stiffness (Chord Modulus) with little to no effect on the impact resistance. The addition of a compatibilizing agent results in an increase in the impact strength as shown by a comparison of C.S. 25A and C.S. 25B (formulations with Vistamaxx 6202), C.S. 27A and C. S. 27B (formulations with Kraton G6142) and C.S. 29A and C.S. 29B (formulations with Infuse 9817). The magnitude of the increase is approximately 27%, 39%, and 47% respectively. Surprisingly, the samples containing both the compabtilizing agent and the nucleating agent exhibited even greater increases in impact strength as is shown in Table 18. Comparing C.S. 26 to Sample 26, C.S. 28 to Sample 28, C.S. 30 to Sample 30, the impact strengths increased by 290%, 256%, and 362%, respectively. Further, Sample 26, 28, and 30 exhibited the desirable partial failures indicating a change in failure mechanism from brittle to ductile compared to C.S. 25, C.S. 27, and C.S. 29. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent.

### EXAMPLE 7

The following example demonstrates the modification of a heterophasic polyolefin composition and performance enhancements achieved according to the present invention using a different type of polypropylene and without adding extra impact modifiers.

Six heterophasic polymer compositions were produced. The general formulation for these samples is set forth in Table 19.

TABLE 19
Heterophasic polypropylene copolymer formulations.

| Component | Loading |
|---|---|
| Polypropylene copolymer (Indelpro GRA1HC5V) | Balance |
| Peroxide (Varox DBPH) | See Table 20 |
| Stabilizer 1 (Irganox ® 1010) | 500 ppm |
| Stabilizer 2 (Irgaphos ® 168) | 1000 ppm |
| Acid Scavenger (DHT-4V) | 400 ppm |
| Nucleating agent | See Table 20 |
| Compatibilizing Agent | See Table 20 |

Each of the compositions listed in Tables 19 and 20 were mixed, extruded, and injection molded according to the above procedure. The resulting pellets were subjected to melt flow rate testing and the bars were tested for impact strength, flexural modulus and thermal properties as described above.

TABLE 20
Heterophasic polypropylene copolymer formulations.

| | | | Varox | |
|---|---|---|---|---|
| | N.A. 5 | N.A. 3 | DBPH | C.A. 1 |
| Sample | (ppm) | (ppm) | (ppm) | (ppm) |
| C.S. 31A | | | 100 | |
| C.S. 31B | | | 800 | 1200 |
| C.S. 32 | 1000 | | 100 | |
| 32 | 1000 | | 800 | 1200 |
| C.S. 33 | | 1000 | 100 | |
| 33 | | 1000 | 800 | 1200 |

TABLE 21
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 31A | 7.9 | 118.2 | 91.1 | 1129 | 6.1 | Complete | |
| C.S. 31B | 10.7 | 119.2 | 92.3 | 1175 | 15.8 | Complete | 159 |
| C.S. 32 | 7.5 | 126.0 | 92.7 | 1385 | 6.3 | Complete | |
| 32 | 11.7 | 126.0 | 95.3 | 1309 | 35.8 | Partial | 468 |
| C.S. 33 | 8.8 | 129.2 | 93.6 | 1555 | 6.2 | Complete | |
| 33 | 11.4 | 128.8 | 92.5 | 1420 | 36.6 | Partial | 490 |

The resin has a nominal MFR of 4 g/10 min. With the addition of peroxide alone, the MFR increased to approximately 8 g/10 min. The addition of the compatibilizing agent and additional peroxide increased the MFR to approximately 10 g/10 min and the stiffness was essentially unchanged. The addition of the nucleating agents (in the absence of the compabitilizing agent) resulted in higher stiffness with no effect on the impact resistance.

The addition of a compatibilizing agent results in an increase in the impact strength as shown by a comparison of C.S. 31A and C.S. 31B. The magnitude of the increase is approximately 159%. Surprisingly, the samples containing both the compabtilizing agent and the nucleating agent exhibited even greater increases in impact strength as is shown in Table 21. Comparing C.S. 32 to Sample 32 and C.S. 33 to Sample 33, the impact strengths increased by 468% and 490%, respectively. In addition, Samples 32 and 33 exhibited the desirable partial failures indicating a change in failure mechanism from brittle to ductile compared to C.S. 32 and C.S. 33. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent. Further, this synergy is observed even when different nucleating agents are used.

### EXAMPLE 8

The following example demonstrates the modification of a heterophasic polyolefin composition and performance enhancements achieved according to the present invention.

Four heterophasic polymer compositions were produced. The general formulation for these samples is set forth in Table 22.

TABLE 22
Heterophasic polypropylene copolymer formulations.

| Component | Loading |
|---|---|
| Polypropylene copolymer (Pinnacle PP 2160H) | Balance |
| Peroxide (Varox DBPH) | See Table 23 |
| Stabilizer 1 (Irganox ® 1010) | 500 ppm |
| Stabilizer 2 (Irgaphos ® 168) | 1000 ppm |
| Acid Scavenger (DHT-4V) | 400 ppm |
| Nucleating agent | See Table 23 |
| Compatibilizing Agent | See Table 23 |

Each of the compositions listed in Tables 22 and 23 were mixed, extruded, and injection molded according to the above procedure. The resulting pellets were subjected to melt flow rate testing and the bars were tested for impact strength, flexural modulus and thermal properties as described above.

TABLE 23
Heterophasic polypropylene copolymer formulations.

| | | Varox | |
|---|---|---|---|
| | N.A. 3 | DBPH | C.A. 1 |
| Sample | (ppm) | (ppm) | (ppm) |
| C.S. 34A | | 100 | |
| C.S. 34B | | 800 | 1200 |
| C.S. 35 | 1000 | 100 | |
| 35 | 1000 | 800 | 1200 |

TABLE 24
Mechanical and thermal properties of formulations.

| | | | | | RT | | Increase |
|---|---|---|---|---|---|---|---|
| | | | | Chord | Notched | | in impact |
| | MFR | Tc | ΔH | Modulus | Izod | Failure | strength |
| Sample | (g/10 min) | (° C.) | (J/g) | (MPa) | (kJ/m²) | Type | (%) |
| C.S. 34A | 16.3 | 121.8 | 115.7 | 1240 | 9.0 | Complete | |
| C.S. 34B | 13.3 | 121.5 | 123.2 | 1188 | 11.2 | Complete | 24 |
| C.S. 35 | 16.8 | 129.2 | 125.4 | 1527 | 8.8 | Complete | |
| 35 | 9.6 | 128.3 | 129.7 | 1283 | 34.3 | Partial | 290 |

The addition of a compatibilizing agent results in an increase in the impact strength as shown by a comparison of C.S. 34A and C.S. 34B. The magnitude of the increase is approximately 24%. Surprisingly, the samples containing both the compabtilizing agent and the nucleating agent exhibited even greater increases in impact strength as is shown in Table 24. Comparing C.S. 35 to Sample 35, the impact strength increases by 290%. In addition, Sample 35 exhibited the desirable partial failures indicating a change in failure mechanism from brittle to ductile compared to C.S. 35. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent.

### EXAMPLE 9

The following example demonstrates the modification of a heterophasic polyolefin composition and performance enhancements achieved according to the present invention.

Four heterophasic polymer compositions were produced. The general formulation for these samples is set forth in Table 25.

TABLE 25
Heterophasic polypropylene copolymer formulations.

| Component | Loading |
|---|---|
| Polypropylene copolymer (Ineos PP 400-CB0H) | Balance |
| Peroxide (Varox DBPH) | See Table 26 |
| Stabilizer 1 (Irganox ® 1010) | 500 ppm |
| Stabilizer 2 (Irgaphos ® 168) | 1000 ppm |
| Acid Scavenger (DHT-4V) | 400 ppm |
| Nucleating agent | See Table 26 |
| Compatibilizing Agent | See Table 26 |

Each of the compositions listed in Tables 22 and 23 were mixed, extruded, and injection molded according to the above procedure. The resulting pellets were subjected to melt flow rate testing and the bars were tested for impact strength, flexural modulus and thermal properties as described above.

TABLE 26
Heterophasic polypropylene copolymer formulations.

| | | Varox | |
|---|---|---|---|
| | N.A. 3 | DBPH | C.A. 1 |
| Sample | (ppm) | (ppm) | (ppm) |
| C.S. 36A | | 100 | |
| C.S. 36B | | 800 | 2000 |
| C.S. 37 | 1000 | 100 | |
| 37 | 1000 | 800 | 2000 |

TABLE 27
Mechanical and thermal properties of formulations.

| | | | | | Increase | | | Increase |
|---|---|---|---|---|---|---|---|---|
| | | | RT | | in impact | 0° C. | | in impact |
| | | Chord | Notched | | strength | Notched | | strength |
| | MFR | Modulus | Izod | Failure | @ RT | Izod | Failure | @ 0° C. |
| Sample | (g/10 min) | (MPa) | (kJ/m²) | Type | (%) | (kJ/m²) | Type | (%) |
| C.S. 36A | 21.9 | 1267 | 7.1 | Complete | | 4.6 | Complete | |
| C.S. 36B | 25.2 | 1233 | 10.7 | Complete | 51 | 5.4 | Complete | 17 |
| C.S. 37 | 24.9 | 1637 | 7.3 | Complete | | 5.2 | Complete | |
| 37 | 28.5 | 1542 | 33.25 | Partial | 355 | 7.1 | Complete | 37 |

The virgin resin has a nominal MFR of 10 g/10 min. When the peroxide is added, the MFR increased to approximately 22 g/10 min. When the compatibilizing agent and additional peroxide are added, the MFR increased to approximately 25 g/10 min and the stiffness showed a slight decrease. The addition of the nucleating agent resulted in an increase in the stiffness (Chord Modulus) with minimal impact on the impact resistance.

The addition of a compatibilizing agent resulted in an increase in the impact strength as shown by a comparison of C.S. 36A and C.S. 36B when tested at both room temperature and at 0° C. The magnitude of the increase is approximately 51% at RT and 17% at 0° C. Surprisingly, the samples containing both the compabtilizing agent and the nucleating agent exhibited even greater increases in impact strength as is shown in Table 27. Comparing C.S. 37 to Sample 37, the impact strength at RT increased by 355% and at 0° C. by 37. In addition, Sample 37 exhibited the desirable partial failures at RT indicating a change in failure mechanism from brittle to ductile compared to C.S. 37. These dramatic increases in impact resistance of the samples is unexpected because the addition of the nucleating agent typically does not affect the impact resistance or even leads to a slight deterioration in the impact resistance. It is believed that these results demonstrate a synergistic effect attributable to the combination of the compatibilizing agent and the nucleating agent.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A heterophasic polymer composition comprising:
(a) a propylene polymer phase comprising propylene polymers selected from the group consisting of polypropylene homopolymers and copolymers of propylene and up to 50 wt. % of one or more comonomers selected from the group consisting of ethylene and C₄-C₁₀ α-olefin monomers;
(b) an ethylene polymer phase comprising ethylene polymers selected from the group consisting of ethylene homopolymers and copolymers of ethylene and one or more C₃-C₁₀ α-olefin monomers;
(c) a compatibilizing agent comprising a fulvene moiety; and
(d) a nucleating agent.

2. The heterophasic polymer composition of claim 1, wherein the compatibilizing agent is selected from the group consisting of compounds comprising a moiety conforming to the structure of Formula (EI), compounds comprising a moiety conforming to the structure of Formula (EIII), and compounds conforming to the structure of Formula (EV) 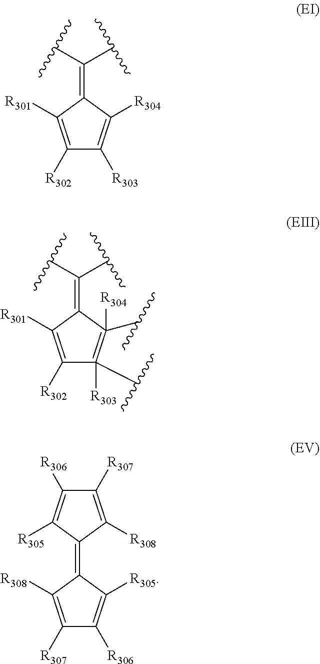
wherein R₃₀₁, R₃₀₂, R₃₀₃, and R₃₀₄ are independently selected from the group consisting of hydrogen, halogens, hydrocarbyl groups, and substituted hydrocarbyl groups, provided adjacent hydrocarbyl groups or substituted hydrocarbyl groups can be combined to form a secondary ring fused to the ring of the moiety and provided at least one of R₃₀₁, R₃₀₂, R₃₀₃, and R₃₀₄ is a hydrogen; and R₃₀₅, R₃₀₆, R₃₀₇, and R₃₀₈ are independently selected from the group consisting of halogens.

3. The heterophasic polymer composition of claim 2, wherein the compatibilizing agent is a compound of Formula (EX) 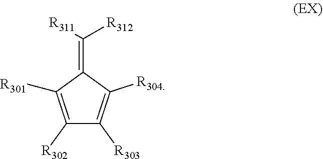
wherein R₃₀₁, R₃₀₂, R₃₀₃, and R₃₀₄ are independently selected from the group consisting of hydrogen, halogens, hydrocarbyl groups, and substituted hydrocarbyl groups, provided adjacent hydrocarbyl groups or substituted hydrocarbyl groups can be combined to form a secondary ring fused to the ring of the moiety and provided at least one of R₃₀₁, R₃₀₂, R₃₀₃, and R₃₀₄ is a hydrogen; and R₃₁₁ and R₃₁₂ are individual substituents independently selected from the group consisting of hydrogen, alkyl groups, substituted alkyl groups, alkenyl groups, substituted alkenyl groups, amine groups, substituted amine groups, aryl groups, substituted aryl groups, heteroaryl groups, and substituted heteroaryl groups or R₃₁₁ and R₃₁₂ together form a single substituent selected from the group consisting of aryl groups, substituted aryl groups, heteroaryl groups, and substituted heteroaryl groups.

4. The heterophasic polymer composition of claim 3, wherein R₃₀₁, R_{302,} R₃₀₃, and R₃₀₄ are independently selected from the group consisting of hydrogen, halogens, alkyl groups, substituted alkyl groups, aromatic groups, substituted aromatic groups, heteroaromatic groups, and substituted heteroaromatic groups.

5. The heterophasic polymer composition of claim 4, wherein R₃₀₁, R_{302,} R₃₀₃, and R₃₀₄ are each hydrogen.

6. The heterophasic polymer composition of claim 3, wherein R₃₁₁ and R₃₁₂ are independently selected from the group consisting of aryl groups, substituted aryl groups, heteroaryl groups, and substituted heteroaryl groups.

7. The heterophasic polymer composition of claim 6, wherein R₃₁₁ and R₃₁₂ are each phenyl.

8. The heterophasic polymer composition of claim 1, wherein the nucleating agent comprises phosphate ester anions of Formula (I) 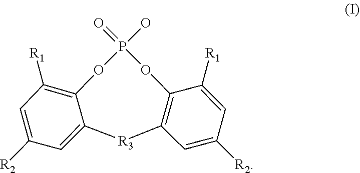
wherein R₁ and R₂ are independently selected from the group consisting of hydrogen and C₁-C₁₈ alkyl groups, and R₃ is an alkanediyl group.

9. The heterophasic polymer composition of claim 1, wherein the nucleating agent comprises aromatic carboxylate anions.

10. The heterophasic polymer composition of claim 1, wherein the nucleating agent comprises cycloaliphatic dicarboxylate anions selected from the group consisting of Formula (X) and Formula (XX) 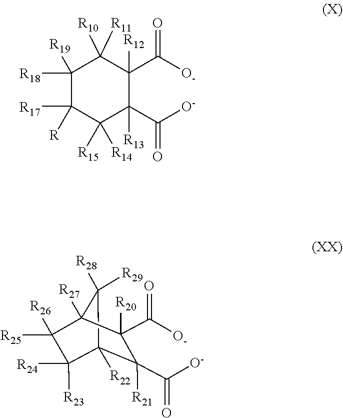
wherein R₁₀, R₁₁, R₁₂, R₁₃, R₁₄, R₁₅, R₁₆, R₁₇, R₁₈, and R₁₉ are independently selected from the group consisting of hydrogen, halogens, C₁-C₉ alkyl groups, C₁-C₉ alkoxy groups, and C₁-C₉ alkylamine groups; and R₂₀, R₂₁, R₂₂, R₂₃, R₂₄, R₂₅, R₂₆, R₂₇, R₂₈, and R₂₉ are independently selected from the group consisting of hydrogen, halogens, C₁-C₉ alkyl groups, C₁-C₉ alkoxy groups, and C₁-C₉ alkylamine groups.

11. A method for modifying a heterophasic polymer composition, the method comprising the steps of:
(a) providing a compatibilizing agent, the compatibilizing agent comprising a fulvene moiety;
(b) providing a nucleating agent; (c) providing a heterophasic polymer composition, the heterophasic polymer composition comprising a propylene polymer phase and an ethylene polymer phase;
(d) mixing the compatibilizing agent, the nucleating agent, and the heterophasic polymer composition; and
(e) generating free radicals in the propylene polymer phase and the ethylene polymer phase, whereby at least a portion of the compatibilizing agent reacts with free radicals in both the propylene polymer phase and the ethylene polymer phase to form a bond with a propylene polymer in the propylene polymer phase and a bond with an ethylene polymer in the ethylene polymer phase.

12. The method of claim 11, wherein the compatibilizing agent is selected from the group consisting of compounds comprising a moiety conforming to the structure of Formula (E1), compounds comprising a moiety conforming to the structure of Formula (EIII), and compounds conforming to the structure of Formula (EV) 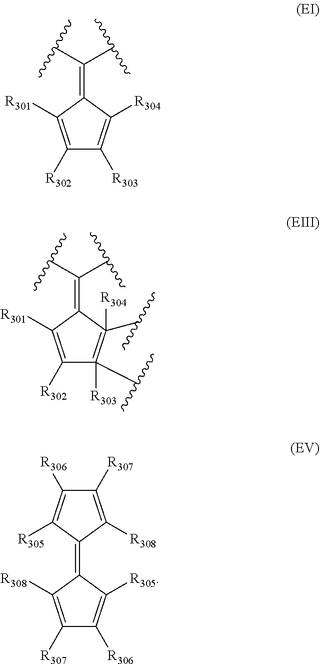
wherein R₃₀₁, R₃₀₂, R₃₀₃, and R₃₀₄ are independently selected from the group consisting of hydrogen, halogens, hydrocarbyl groups, and substituted hydrocarbyl groups, provided adjacent hydrocarbyl groups or substituted hydrocarbyl groups can be combined to form a secondary ring fused to the ring of the moiety and provided at least one of R₃₀₁, R₃₀₂, R₃₀₃, and R₃₀₄ is a hydrogen; and R₃₀₅, R₃₀₆, R₃₀₇, and R₃₀₈ are independently selected from the group consisting of halogens.

13. The method of claim 12, wherein the compatibilizing agent is a compound of Formula (EX) 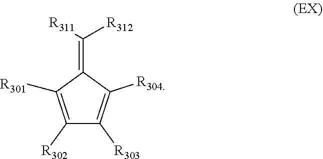
wherein R₃₀₁, R₃₀₂, R₃₀₃, and R₃₀₄ are independently selected from the group consisting of hydrogen, halogens, hydrocarbyl groups, and substituted hydrocarbyl groups, provided adjacent hydrocarbyl groups or substituted hydrocarbyl groups can be combined to form a secondary ring fused to the ring of the moiety and provided at least one of R₃₀₁, R₃₀₂, R₃₀₃, and R₃₀₄ is a hydrogen; and R₃₁₁ and R₃₁₂ are individual substituents independently selected from the group consisting of hydrogen, alkyl groups, substituted alkyl groups, alkenyl groups, substituted alkenyl groups, amine groups, substituted amine groups, aryl groups, substituted aryl groups, heteroaryl groups, and substituted heteroaryl groups or R₃₁₁ and R₃₁₂ together form a single substituent selected from the group consisting of aryl groups, substituted aryl groups, heteroaryl groups, and substituted heteroaryl groups.

14. The method of claim 13, wherein R₃₀₁, R₃₀₂, R₃₀₃, and R₃₀₄ are independently selected from the group consisting of hydrogen, halogens, alkyl groups, substituted alkyl groups, aromatic groups, substituted aromatic groups, heteroaromatic groups, and substituted heteroaromatic groups.

15. The method of claim 14, wherein R₃₀₁, R₃₀₂, R₃₀₃, and R₃₀₄ are each hydrogen.

16. The method of claim 13, wherein R₃₁₁ and R₃₁₂ are independently selected from the group consisting of aryl groups, substituted aryl groups, heteroaryl groups, and substituted heteroaryl groups.

17. The method of claim 16, wherein R₃₁₁ and R₃₁₂ are each phenyl.

18. The method of claim 11, wherein the nucleating agent comprises phosphate ester anions of Formula (I) 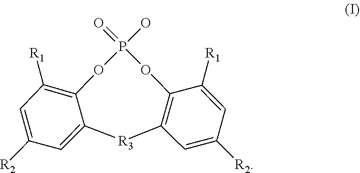
wherein R₁ and R₂ are independently selected from the group consisting of hydrogen and C₁-C₁₈ alkyl groups, and R₃ is an alkanediyl group.

19. The method of claim 11, wherein the nucleating agent comprises aromatic carboxylate anions.

20. The method of claim 11, wherein the nucleating agent comprises cycloaliphatic dicarboxylate anions selected from the group consisting of Formula (X) and Formula (XX) 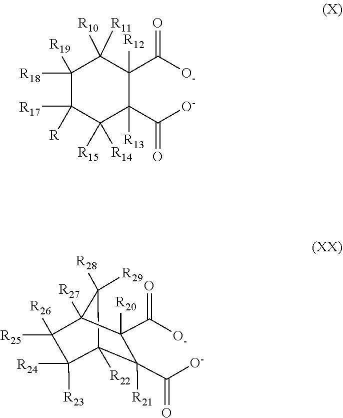
wherein R₁₀, R₁₁, R₁₂, R₁₃, R₁₄, R₁₅, R₁₆, R₁₇, R₁₈, and R₁₉ are independently selected from the group consisting of hydrogen, halogens, C₁-C₉ alkyl groups, C₁-C₉ alkoxy groups, and C₁-C₉ alkylamine groups; and R₂₀, R₂₁, R₂₂, R₂₃, R₂₄, R₂₅, R₂₆, R₂₇, R₂₈, and R₂₉ are independently selected from the group consisting of hydrogen, halogens, C₁-C₉ alkyl groups, C₁-C₉ alkoxy groups, and C₁-C₉ alkylamine groups.
